(19) United States
(12) Patent Application Publication
(10) Pub. No.: US 2026/0366318 A1
(43) Pub. Date: Nov. 19, 2026

(54) ENERGY DISSIPATION DEVICE

(71) Applicant: Kaveh ANDISHEH, Auckland (NZ)

(72) Inventor: Kaveh ANDISHEH, Auckland (NZ)

(21) Appl. No.: 19/714,341

(22) Filed: Jun. 19, 2026

Related U.S. Application Data
(63) Continuation-in-part of application No. PCT/IB2023/063165, filed on Dec. 22, 2023.

(51) Int. Cl. E04H 9/02

(52) U.S. Cl. CPC E04H 9/021

(57) ABSTRACT

An energy dissipation device for use in a lateral force-resisting structure for dissipating seismic or wind-induced energy is disclosed. The energy dissipation device is arranged to be connected to a structural component at either end of the energy dissipation device and comprises energy-absorbing elements that are directly or indirectly connected between two web plates of the energy dissipation device. The energy dissipation device may comprise a one to three-dimensional array of the energy-absorbing elements and one or more energy-absorbing elements may be connected, directly or indirectly, to only one end of the energy dissipation device, resulting in no energy dissipation, but may allow for connection to both ends of the energy dissipation device when one or more other energy-absorbing elements are deformed from energy dissipation to quickly repair the energy dissipation device after a high lateral force event.

### BACKGROUND OF THE INVENTION

The present invention relates to an energy dissipation device. More particularly but not exclusively it relates to an energy dissipation device for use in a lateral force-resisting system/structure for dissipating seismic or wind-induced energy.

Energy dissipation devices are used in structures to dissipate vibration induced by wind or energy generated by seismic events or other types of loading. Various energy dissipation devices are widely used, for different applications, to reduce or eliminate damage to structures or systems. However, there are limited devices that can efficiently dissipate energy when subjected to shear loading. Generally, low-damage seismic solutions have been criticised for raising the cost of structures and the low probability of returning investment during the structures' lifetime. Some devices, such as viscous dampers, require specialist design and manufacturing processes, adding more complexity and cost to the project. The long-term performance of some devices, such as friction connections, cannot be predicted when exposed to the environment. So, their applications are limited, and their conditions need inspection regularly. Some low-damage seismic solutions are not reusable after a severe earthquake, so they cannot meet sustainability requirements. Replacement of most damaged dissipators and low-damage systems is expensive, and it increases the critical risk to buildings and the safety of the occupants during the replacement process, as the structures' resisting systems do not properly work during the replacement period.

### OBJECT OF THE INVENTION

It is an object of the present invention to provide an energy dissipation device which overcomes or at least partially ameliorates some of the abovementioned disadvantages, or which at least provides the public with a useful choice.

### STATEMENTS OF INVENTION

In a first aspect, the present invention resides in an energy dissipation device for use in a lateral force-resisting structure for dissipating seismic or wind-induced energy, wherein the energy dissipation device is arranged to extend along a longitudinal axis to span between a first structural component of the lateral force-resisting structure and a second structural component of the lateral force resisting structure for energy dissipative coupling therebetween, the energy dissipation device comprising:
a. a first web plate for securing to the first structural component and arranged to extend therefrom towards the second structural component;
b. a second web plate for securing to the second structural component and arranged to extend therefrom towards the first structural component; wherein the first web plate and the second web plate are separated to allow the web plates to move (preferably transversely or axially) relative to one another in response to relative movement (preferably shear or axial movement) of the first and second structural components; and
c. an array of energy-absorbing elements coupling the first web plate to the second web plate, wherein the array has at least two orthogonal dimensions comprising of at least one row and at least one column, wherein that at least one row is defined by:
one or more energy-absorbing elements of the array of energy-absorbing elements aligned along a respective axis parallel to the longitudinal axis, and
wherein at least one column is defined by:
one or more energy-absorbing elements of the array of energy-absorbing elements aligned along a respective axis orthogonal to the longitudinal axis; wherein the one or more energy-absorbing elements comprise a U-shaped flexural plate (UFP) and is directly or indirectly secured to the first web plate and to the second web plate so as to deform in response to said relative movement (preferably shear or axial movement) of the first and second structural components thereby dissipating energy.

Preferably the energy dissipating device comprises the second web plate for securing to the second structural component and arranged to extend therefrom towards the first structural component; wherein the first web plate and the second web plate are separated to allow the web plates to move (preferably transversely or axially) relative to one another in response to relative movement (preferably shear or axial movement) of the first and second structural components; and wherein the spacing between the first and second web plates defines a displacement threshold such that, under design-level displacement, energy dissipation and stiffness are primarily governed by deformation of the energy-absorbing elements, and wherein, upon exceeding the threshold, the web plates are configured to engage to provide additional load transfer, increased stiffness, and increased load-carrying capacity, together with further energy dissipation; and

Preferably, the array has at least two orthogonal dimensions comprising of a plurality of rows and a plurality of columns, wherein each row is defined by the one or more energy-absorbing elements of the array of energy-absorbing elements aligned along a respective axis parallel to the longitudinal axis.

Preferably, each column is defined by one or more energy-absorbing elements of the array of energy-absorbing elements aligned along a respective axis orthogonal to the longitudinal axis; wherein the energy-absorbing elements comprise the U-shaped flexural plate (UFP) and are directly or indirectly secured to the first web plate and to the second web plate so as to deform in response to said relative movement of the first and second structural components thereby dissipating energy.

Preferably, the first web plate and the second web plate are co-planar.

Preferably, each web plate is a variable cross-section plate having a tapered edge, and wherein the web plates are arranged such that the tapered edges are adjacent and define a diagonal spacing therebetween.

Preferably, the energy dissipation device further comprises a plurality of parallel connectors distributed along the longitudinal axis and successively alternating in connection to the first web plate or to the second web plate, wherein the one or more energy-absorbing elements in each column of the array are directly or indirectly secured between two successive parallel connectors to thereby secure the energy-absorbing elements of the array to the first web plate and to the second web plate.

Preferably, the one or more energy-absorbing elements in the at least one row is an odd number, and the plurality of parallel connectors is an even number, for reducing unbalanced shear loads across the web plates.

Preferably, the one or more energy-absorbing elements in the at least one row is an even number.

Preferably, the plurality of parallel connectors is an odd number.

Preferably, the array is arranged such that one side of the web plates is flanked by UFPs.

Preferably, the array of energy-absorbing elements has three orthogonal dimensions, the third dimension defined by a plurality of columns.

Preferably, the array is arranged such that both sides of the web plates are flanked by UFPs for reducing torsional load on the energy dissipation device.

Preferably, the array is arranged such that both sides of the web plates are flanked by UFPs for reducing torsional moment or coupled forces on the energy dissipation device or for reducing the resultant of unbalanced resisted forces by the energy dissipation device.

Preferably, the one or more energy-absorbing elements in at least one row are rotationally aligned.

Preferably, the one or more energy-absorbing elements in the at least one column are rotationally aligned.

Preferably, the UFPs are orientated such that the legs of each UFP lie on a plane parallel to the longitudinal axis.

Preferably, wherein the energy-absorbing elements comprise a coupled arrangement of two or more UFPs.

Preferably, the one or more energy-absorbing elements of the array of energy-absorbing elements comprise a mirrored pair of UFPs in a pill-shape configuration.

Preferably, the one or more energy-absorbing elements of the array of energy-absorbing elements comprise a mirrored pair of UFPs arranged in an oval slot shaped or substantially oval slot shaped configuration.

Preferably, the invention further comprises a resilient biaser secured between the first web plate and the second web plate and arranged to urge the web plates into a predetermined relative transverse position.

Preferably, the resilient biaser is a tension-compression friction spring.

Preferably, the resilient biaser is positioned centrally along the longitudinal axis within the array.

Preferably, the energy dissipation device further comprises one or more redundant UFPs secured to a single web plate so as to be free at one end.

Preferably, the energy dissipation device is a shear link.

Preferably, the energy dissipation device comprises a shear link.

Preferably, the energy dissipation device is an axial link.

Preferably, the energy dissipation device comprises an axial link.

In a second aspect, the present invention resides in an energy dissipation device for use in a lateral force-resisting structure for dissipating seismic or wind-induced energy, wherein the energy dissipation device is arranged to extend along a longitudinal axis to span between a first structural component of the lateral force-resisting structure and a second structural component of the lateral force resisting structure for energy dissipative coupling therebetween, the energy dissipation device comprising:
a. a first web plate for securing to the first structural component and arranged to extend therefrom towards the second structural component;
b. a second web plate for securing to the second structural component and arranged to extend therefrom towards the first structural component; wherein the first web plate and the second web plate are separated to allow the web plates to move transversely relative to one another in response to relative movement (preferably shear or axial movement) of the first and second structural components; and
c. an array of energy-absorbing elements coupling the first web plate to the second web plate, wherein the array has at least two orthogonal dimensions comprising of a plurality of rows and a plurality of columns, wherein each row is defined by:
a plurality of energy-absorbing elements aligned along a respective axis parallel to the longitudinal axis, and
wherein each column is defined by:
a plurality of energy-absorbing elements aligned along a respective axis orthogonal to the longitudinal axis; wherein each energy-absorbing element comprises a U-shaped flexural plate (UFP) and is directly or indirectly secured to the first web plate and to the second web plate so as to deform in response to said relative movement (preferably shear or axial movement) of the first and second structural components thereby dissipating energy.

Preferably, the first web plate and the second web plate are co-planar.

Preferably, each web plate is a variable cross-section plate having a tapered edge, and wherein the web plates are arranged such that the tapered edges are adjacent and define a diagonal spacing therebetween.

Preferably, the energy dissipation device further comprises a plurality of parallel connectors distributed along the longitudinal axis and successively alternating in connection to the first web plate or to the second web plate, wherein the energy-absorbing elements in each column of the array are directly or indirectly secured between two successive parallel connectors to thereby secure each energy-absorbing element of the array to the first web plate and to the second web plate.

Preferably, the plurality of energy-absorbing elements in each row is an odd number and the plurality of parallel connectors is an even number, for reducing unbalanced shear loads across the web plates.

Preferably, the array is arranged such that one side of the web plates is flanked by UFPs.

Preferably, the array of energy-absorbing elements has three orthogonal dimensions, the third dimension defined by a plurality of layers each having a plurality of rows and columns.

Preferably, the array is arranged such that both sides of the web plates are flanked by UFPs for reducing torsional load on the energy dissipation device.

Preferably, the energy-absorbing elements in each row are rotationally aligned.

Preferably, the energy-absorbing elements in each column are rotationally aligned.

Preferably, the UFPs are orientated such that the legs of each UFP lie on a plane parallel to the longitudinal axis.

Preferably, wherein each energy-absorbing element comprises a coupled arrangement of two or more UFPs.

Preferably, each energy-absorbing element comprises a mirrored pair of UFPs in a pill-shape configuration.

Preferably, each energy-absorbing element comprises a mirrored pair of UFPs arranged in an oval slot shaped or substantially oval slot shaped configuration.

Preferably, the invention further comprises a resilient biaser secured between the first web plate and the second web plate and arranged to urge the web plates into a predetermined relative transverse position.

Preferably, the resilient biaser is a tension-compression friction spring.

Preferably, the resilient biaser is positioned centrally along the longitudinal axis within the array.

Preferably, the energy dissipation device further comprises one or more redundant UFPs secured to a single web plate so as to be free at one end.

Preferably, the energy dissipation device is a shear link.

Preferably, the energy dissipation device comprises a shear link.

In a third aspect, the present invention resides in an energy dissipation device for energy dissipative coupling between beams of an eccentrically braced frame (EBF), said beams spaced apart horizontally, the energy dissipation device comprising:
a pair of spaced web plates partially overlapping to span discontinuously between the beams of the EBF, wherein the web plates are arranged to move in-plane transversely relative to one another in response to shear forces across the beams of the EBF;
a plurality of U-shaped flexural plates (UFPs) arranged in parallel rows to flank the web plates on at least one side, wherein each row comprises UFPs extending along a horizontal axis to define a length dimension;
wherein each UFP comprises a first leg secured to a first web plate of the pair and a second leg secured to a second web plate of the pair such that, in response to shear load applied across the web plates, substantially equal force is applied across each UFP so as to yield each UFP predictably substantially independently, or at least in reduced dependence, of the length dimension.

Preferably, each row comprises two or more rotationally aligned UFPs.

In a fourth aspect, the present invention resides in an eccentrically braced frame comprising:
a. a first beam and a second beam; and
b. the energy dissipation device of any one of the preceding statements, wherein the energy dissipation device connects horizontally between the first braced beam to the second braced beam.

Preferably, the first beam is a first braced beam.

Preferably, the second beam is a second brace beam.

In a fifth aspect, the present invention resides in an energy dissipation device for energy dissipative coupling between a first structural component and a second structural component, the energy dissipation device comprising:
a first web plate for extending from the first structural component and a second web plate for extending from the second structural component, wherein the first web plate and the second web plate are separated by a gap;
an array of energy-absorbing elements coupling the first web plate to the second web plate across the gap, wherein the array comprises one or more of:
   i. a first dimension having a sequence of energy-absorbing elements arranged in a first direction substantially parallel to a shear load;
   ii. a second dimension having a sequence of energy-absorbing elements arranged in a second direction substantially orthogonal to the shear load; and
   iii. a third dimension having a sequence of energy-absorbing elements arranged in a third direction substantially orthogonal to both the first direction and the second direction;
wherein the array of energy-absorbing elements is configured to dissipate energy generated by relative movement (preferably shear or axial movement) of the first and second structural components.

Preferably the energy dissipating device comprises said first web plate for extending from the first structural component and a second web plate for extending from the second structural component, wherein the first web plate and the second web plate are separated by a gap; and wherein the gap defines a displacement threshold below which the web plates remain non-contacting and stiffness and energy dissipation are primarily governed by the energy-absorbing elements, and above which the web plates are configured to engage to provide additional stiffness, load-carrying capacity, energy dissipation, and load transfer.

Preferably, the first web plate and the second web plate are co-planar in a plane parallel to the second direction, and the energy dissipation device further comprises a series of parallel connectors alternately connected to the first web plate or the second web plate, wherein each element of the second dimension is connected between two successive parallel connectors.

Preferably, the sequence of energy-absorbing elements in the second dimension is an odd number and the series of parallel connectors is an even number.

Preferably, the first web plate and the second web plate are arranged on parallel planes and wherein the array of energy-absorbing elements is arranged between the parallel planes.

Preferably, the energy dissipation device further comprises:
a. a third web plate for extending from the first structural component and separated from the second web plate by a second gap, wherein the first, second and third web plates are arranged on parallel planes; and
b. a second array of energy-absorbing elements coupling the second web plate to the third web plate across the gap.

Preferably, at least one of the energy-absorbing elements comprises a flexural dissipator, such as one or more U-shaped flexural plates (UFPs).

In a sixth aspect, the present invention resides in a building structure comprising:
a. a first structural component and a second structural component; and
b. the energy dissipation device of any one of the preceding statements, wherein the energy dissipation device couples the first structural component to the second structural component.

In a seventh aspect, the present invention resides in an energy dissipation device to locate across a gap intermediate of a first structural component and a second structural component to connect the first and second structural components together and allow their relative motion in a shear direction said energy dissipation device comprising an array of a plurality of energy-absorbing elements each element comprising a first end region at where the element is connected to move directly with the first structural component and a second end region at where the element is connected to move directly with the second structural component so that during said relative motion the first and second end regions move relative each other and wherein intermediate of the two end regions the element is able to absorb and dissipate energy generated during said relative motion that is transferred from the first structural component and second structural component to the element.

Preferably, the element is able to absorb and dissipate energy generated during said relative motion that is transferred from the structural components to the element by virtue of the element, intermediate of the first and second end region, comprising of an intermediate energy absorber region.

Preferably, the energy absorber region is resiliently flexible.

Preferably, the energy absorber region is able to yield.

Preferably, the energy absorber region is able to plastically yield.

Preferably, the element is a flexural member.

Preferably, the element is a uniform flexural plate.

Preferably, the element is a U-shaped flexural plate of metal.

Preferably, the U-shaped flexural plate is substantially of a U shape wherein the two distal ends of that shape correspond to said first and second end regions and the trough between the two distal ends correspond to said energy absorber region.

Preferably, the array comprises of a plurality of said elements arranged and configured to extend across the gap.

Preferably, the elements of the array are arranged in series in an alternating manner so that (i) the first end region of one element in the array is together connected with the first end region of an immediately adjacent element to move with a first building structure and (ii) the second end region of one element in the array is together connected with the second end region of an immediately adjacent element to move with a second building structure.

Preferably, first end regions of adjacent elements in the array are paired together to move with the first building structure and second end regions of adjacent elements in the array are paired together to move with the second building structure.

Preferably, the element at a first distal end of the array has its first end region not so paired (i. e the first end region is free of connection to the second building structure) but is connected to move with the first building structure.

Preferably, the element at a first distal end of the array has its first end region connected to move with the first building structure.

Preferably, the element at a second distal end of the array has its second end region not so paired (i. e the first end region is free of connection to the first building structure) but is connected to move with the second building structure.

Preferably, the first structural component is of a or the first building structure and the second structural component is of a or the second building structure.

Preferably, the first structural component and the second structural component are of the same building structure.

Preferably, the energy dissipation device is a shear link.

Preferably, the energy dissipation device comprises a shear link.

In an eighth aspect, the present invention resides in an energy dissipation device for energy dissipative coupling between a first structural component and a second structural component, wherein the energy dissipation device comprises: a first web plate for extending from the first structural component and a second web plate for extending from the second structural component, wherein the first web plate and the second web plate are separated by a gap; and an array of energy-absorbing elements coupling the first web plate to the second web plate across the gap, wherein the array comprises one or more of:
(i) a first dimension having a sequence of energy-absorbing elements arranged in a first direction substantially parallel to a shear load;
(ii) a second dimension having a sequence of energy-absorbing elements arranged in a second direction substantially orthogonal to the shear load;
(iii) a third dimension having a sequence of energy-absorbing elements arranged in a third direction substantially orthogonal to both the first direction and the second direction.

Preferably, the array of energy-absorbing elements is configured to dissipate energy generated by relative shear movement of the first and second structural components.

Preferably, the energy dissipation device is located in a gap between the first structural component and the second structural component, wherein the energy dissipation device permits relative movement of the first and second structural components in a shear direction.

Preferably, the web plates, which are webs of a structural beam (e.g., substantially plate-shaped), are for connecting to a respective structural component and extending partially across the gap between the two structural components, wherein the web plates are connectable to their respective structural component, (e.g., a fixed connection via respective end plates) such that relative shear movement of the structural components causes a corresponding relative movement of the web plates, wherein the array of energy-absorbing elements permits the relative movement of the web plates while absorbing energy.

Preferably, the first dimension is a column.

Preferably, the second dimension is a row.

Preferably, the third dimension is another row, or a layering or stack.

Preferably, the first web plate and the second web plate are co-planar in a plane parallel to the second direction.

Preferably, the energy dissipation device further comprise a series of parallel connectors alternately connected to the first web plate or the second web plate, wherein each element of the second dimension is connected between two successive parallel connectors.

Preferably, the parallel connectors are a weld plate or the like oriented normal to the plane of the first and second web plates.

Preferably, each intermediate connector is connected to an end of at least one energy-absorbing element.

Preferably, the sequence of energy-absorbing elements in the second dimension is an odd number and the series of parallel connectors is an even number, wherein the shear load applied to the web plates is substantially balanced.

Preferably, the array of energy-absorbing elements is a first array arranged on one side of the co-planar web plates and the energy dissipation device further comprises a second array of energy-absorbing elements coupling the first web plate to the second web plate across the gap, wherein the second array is arranged on the other side of the co-planar web plates, wherein the shear load applied to the web plate is substantially balanced.

Alternatively, the first web plate and the second web plate are arranged on parallel planes, offset from each other, wherein the array of energy-absorbing elements is arranged between the parallel planes.

Preferably, the energy dissipation device further comprises a third web plate extending from the first structural component and arranged on a further parallel plane, separated from the second web plate by a second gap.

Preferably, the energy dissipation device comprises a second array of energy-absorbing elements coupling the second web plate to the third web plate across the second gap.

Preferably, one or more of the energy-absorbing elements comprises a flexural dissipator.

Preferably, one or more of the energy-absorbing elements comprises one or more U-shaped flexural plates, UFPs.

Preferably, the UFPs are cut from a sheet of material, such as steel, and bent out-of-plane into a U-shape.

Preferably, the U-shape has two substantially parallel legs connected by a bent portion (preferably a semi-circular section).

Preferably, the UFPs are arranged such that shear movement of the first and second structural components causes the bent portion to roll along the UFP.,

Preferably, the yield point of the UFP can move along the UFP during shear movement of the structural components.

Preferably, the UFP dissipates energy via plastic deformation.

Preferably, the energy dissipation device is a shear link.

Preferably, the energy dissipation device comprises a shear link.

In a ninth aspect, the invention resides in an energy dissipation device for energy dissipation in a building structure, the energy dissipation device comprising:
a plurality of web plates comprising a first web plate and a second web plate separated by a gap;
at least one deformable element coupling the first web plate and the second web plate across the gap, wherein the at least one link element is configured to dissipate energy when the energy dissipation device is subjected to shear loads by the building structure.

Preferably, the energy dissipation device comprises an array of deformable elements.

Preferably, the array is a one-dimensional array, a two-dimensional array, or a three-dimensional array.

Preferably, the one-dimensional array is or comprises a column and/or a row.

Preferably, the two-dimensional array is or comprises a layer of at least one row and at least one column.

Preferably, the three-dimensional array comprises a plurality of parallel layers.

Preferably, the at least one deformable element comprises a flexural dissipator.

Preferably the at least one deformable element comprises a U-shaped flexural plate, UFP.

Preferably, the at least one deformable element comprises a pair of UFPs.

Preferably, the at least one deformable element comprises a pair of UFPs arranged in a pill-shape configuration.

Preferably, the at least one deformable element comprises a pair of UFPs arranged in an oval slot shaped or substantially oval slot shaped configuration.

Preferably, the at least one deformable element comprises at least two UFPs stacked concentrically.

Preferably, the at least one deformable element comprises at least two UFPs positioned within a larger UFP.

Preferably, the at least one deformable element comprises a chain of two of more UFPs.

Preferably, the at least one deformable element is a deformable element configured to provide a restoring force for biasing the web plates to a predetermined position.

Preferably, the at least one deformable element comprises a tension-compression friction spring or a damped spring.

Preferably, the web plates are substantially plate-shaped.

Preferably, the at least two web plates have a variable cross-section or a constant cross-section.

Preferably, the first and second web plates are arranged on parallel planes.

Preferably, the at least one deformable element is connected between the first web plate and the second web plate.

Alternatively, the first and second web plates are co-planar.

Preferably, the at least one deformable element is arranged on at least one plane parallel to the co-planar web plates.

Preferably, the energy dissipation device comprises a first array of deformable element on one side of the web plates and a second array of deformable elements on the other side of the web plates.

Preferably, the energy dissipation device comprises at least one redundant deformable element connected to either the first web plate or to the second web plate such that the redundant deformable element does not deform (i.e, said redundant energy-absorbing elements remain in a neutral state, or otherwise experience minimal stress and/or strain) during shear movement of the structural components.

Preferably, the energy dissipation device is a shear link.

Preferably, the energy dissipation device comprises a shear link.

In a tenth aspect, the invention resides in a building structure comprising:
a first structural component and a second structural component; and
the energy dissipation device of any one of the preceding statements, wherein the energy dissipation device couples the first structural component to the second structural component.

Preferably, the structure is an eccentrically braced frame, and the first and second components are beams.

Alternatively, the first and second components are walls.

Preferably, the energy dissipation device is a shear link.

Preferably, the energy dissipation device comprises a shear link.

In an eleventh aspect, the invention resides in an energy dissipation device for providing energy dissipation between two structural components, the energy dissipation device comprising:
at least two web plates separated by a gap;
at least one energy-absorbing element coupling the at least two web plates across the at least one gap, wherein the energy-absorbing element is configured to dissipate energy from and during shear movement of the two structural components.

In a twelfth aspect, the present invention resides in an energy dissipation device to locate across a gap intermediate of a first structural component and a second structural component to connect the first and second structural components together and allow their relative motion in a shear direction said energy dissipation device comprising of an array of a plurality of energy-absorbing elements each comprising of a first end region at where the element is connected to move directly with the first structural component and a second end region at where the element is connected to move directly with the second structural component so that during said relative motion the first and second end regions move relative each other and wherein intermediate of the two end regions the element is able to absorb and dissipate energy generated during said relative motion that is transferred from the structural components to the element.

Preferably, the element is able to absorb and dissipate energy generated during said relative motion that is transferred from the structural components to the element by virtue of the element, intermediate of the first and second end region, comprising of an intermediate energy absorber region.

Preferably, the energy absorber region is resiliently flexible.

Preferably, the energy absorber region is able to yield.

Preferably, the energy absorber region is able to plastically yield.

Preferably, the element is a flexural member.

Preferably, the element is a uniform flexural plate.

Preferably, the element is a uniform flexural plate of metal.

Preferably, the uniform flexural plate is substantially of a U shape wherein the two distal ends of that shape correspond to said first and second end regions and the trough between the two distal ends correspond to said energy absorber region.

Preferably, the array comprises of a plurality of said elements arranged and configured to extend across the gap.

Preferably the elements of the array are arranged in series in an alternating manner so that (i) the first end region of one element in the array is together connected with the first end region of an immediately adjacent element to move with the first structural component and (ii) the second end region of one element in the array is together connected with the second end region of an immediately adjacent element to move with the second structural component.

Preferably the first end regions of adjacent elements in the array are paired together to move with the first structural component and the second end regions of adjacent elements in the array are paired together to move with the second structural component.

Preferably an element at a first distal end of the array has its first end region not so paired but is connected to move with the first structural component.

Preferably an element at a second distal end of the array has its second end region not so paired but is connected to move with the second structural component.

Preferably the first structural component is of a first structural component and the second structural component is of the second structural component.

Preferably the first structural component and the second structural component are of the same building structure.

In a thirteenth aspect, the present invention resides in an energy dissipation device to absorb energy when two or more members move transversally, wherein the energy dissipation device comprises: first and second web plates connected to end plates of the energy dissipation device and movable transversally related to each other, a plurality of parallel connectors alternatively connected to the first and second web plates, the three-dimensional distribution of U shape flexural plates (UFPs) arranged between parallel connectors.

Preferably, UFPs, tension-compression frictional springs, or other types of springs (or dampers) are connected to the parallel connectors.

Preferably, UFPs, tension-compression frictional springs, or other types of springs (or dampers) are directly connected to the web plates.

Preferably, the energy dissipation device have or not have pinned end axial members, which are connected to the end plates of the energy dissipation device.

Preferably, the energy dissipation device is a shear link.

Preferably, the energy dissipation device comprises a shear link.

In a fourteenth aspect, the invention provides an energy dissipation device for providing energy dissipation in structures comprising: variable or constant cross section web plates having longitudinal direction, moveable transversally when shear loads are applied perpendicular to longitudinal direction.

Preferably, the web plates are connected in-plane to end plates at right and left of the link.

Preferably, a plurality of parallel connectors are distributed over a longitudinal direction.

Preferably the plurality of parallel connectors are located at both sides of the web plates.

Preferably, the plurality of parallel connectors are alternatingly-connected to the right and left web plates.

Preferably, three-dimensionally distributed UFPs are connected to the parallel connectors.

Preferably, the UFPs flex when the web plates transversally move upon shear loads applied to the energy dissipation device.

Alternatively, the in-plane web plates are offset and parallel, wherein UFPs can be directly connected to the parallel web plates.

Alternatively, UFPs are replaced by other devices such as tension compression friction spring.

In a fifteenth aspect, the invention resides in a method of resisting (preferably repairably resisting) lateral-loads of a structure comprising:
providing a plurality of energy-absorbing elements, comprising a first portion of said plurality of energy absorbing elements and a second portion of said plurality of energy absorbing elements,
directly or indirectly connecting the first portion of said energy-absorbing elements to a first structural component and a second structural component,
directly or indirectly connecting the second portion of said plurality of energy-absorbing elements to the first structural component, wherein the energy-absorbing elements of the first portion of energy-absorbing elements are subjected to shear load, due to relative movement of the first structural component and second structural component, and dissipate energy, and the energy-absorbing elements of the second portion of energy-absorbing elements are not subjected to shear load (i. e, said second plurality of energy-absorbing elements remain in a neutral state, or otherwise experience minimal stress and/or strain), and
after the first portion of energy-absorbing elements have dissipated significant energy, directly or indirectly connecting the second portion of energy-absorbing elements to the second structural component.

Preferably, the method further comprises:
replacing the first portion of energy-absorbing elements with replacement energy-absorbing elements, wherein when replacing the first portion of energy-absorbing elements the second portion of energy-absorbing elements may dissipate energy due to relative movement of the first structural component and second structural component.

In a sixteenth aspect, the present invention resides in an energy dissipation device for use in a lateral force-resisting structure for dissipating seismic or wind-induced energy, wherein the energy dissipation device is arranged to extend along a longitudinal axis to span between a first structural component of the lateral force-resisting structure and a second structural component of the lateral force resisting structure for energy dissipative coupling therebetween, wherein the longitudinal axis is orthogonal to a transverse axis, the energy dissipation device comprising:
a. a first web plate directly or indirectly secured to the first structural component and arranged to extend therefrom towards the second structural component;
b. a second web plate directly or indirectly secured to the second structural component and arranged to extend therefrom towards the first structural component; wherein the first web plate and the second web plate are separated to allow the web plates to move relative to one another in response to relative movement of the first and second structural components; and
c. an array of energy-absorbing elements coupling the first web plate to the second web plate, wherein the array has at least two orthogonal dimensions comprising of one or more rows and one or more columns, wherein a total number of said rows and columns is equal to three or more, wherein each row is defined by:
one or more energy-absorbing elements distributed along a respective axis parallel to the longitudinal axis,
and wherein each column is defined by:
one or more energy-absorbing elements distributed along a respective axis orthogonal to the longitudinal axis; wherein at least one energy-absorbing element is a U-shaped flexural plate (UFP), wherein a plurality of said energy-absorbing elements are directly or indirectly secured to the first web plate and to the second web plate so as to deform in response to said relative movement of the first and second structural components thereby dissipating energy.

Preferably, at least one of the one or more energy-absorbing elements are positioned concentrically within at least one of the one or more energy-absorbing elements.

Preferably, at least one of the one or more energy-absorbing elements are positioned side-by-side within at least of the one or more energy-absorbing elements.

Preferably, the array of energy-absorbing elements has three orthogonal dimensions, the third dimension defined by a plurality of columns.

Preferably, the array additionally comprises one or redundant energy-absorbing elements, wherein said redundant energy-absorbing elements are directly or indirectly secured to only the first web plate or the second web plate, wherein said redundant energy-absorbing elements are UFPs, wherein said redundant energy-absorbing elements do not deform (i.e, said redundant energy-absorbing elements remain in a neutral state, or otherwise experience minimal stress and/or strain) in response to said relative movement of the first and second structural components thereby not dissipating energy (i.e the dissipation of energy due to the lateral-force is due to substantially the energy-absorbing elements of the array).

Preferably, the first web plate is parallel and to the second web plate, and said first web plate is offset from the second web plate along the transverse axis.

Preferably, the first web plate is co-planar to the second web plate.

Preferably, the web plates are arranged along the longitudinal axis and are adjacent and define a gap therebetween.

Preferably, each web plate is a variable cross-section plate having a tapered edge, and wherein the web plates are arranged such that the tapered edges are adjacent and define a diagonal spacing therebetween.

Preferably, the device further comprises a plurality of parallel connectors distributed along the longitudinal axis and successively alternating in connection to the first web plate or to the second web plate, wherein the energy-absorbing elements in each column of the array are directly or indirectly secured between two successive parallel connectors to thereby secure each energy-absorbing element of the array to the first web plate and to the second web plate.

Preferably, the one or more of energy-absorbing elements in each row is an odd number and the plurality of parallel connectors is an even number, for reducing unbalanced shear loads across the web plates.

Preferably, the one or more of energy-absorbing elements in each row is an even number and the plurality of parallel connectors is an even number, for reducing unbalanced shear loads across the web plates.

Preferably, the web plates move relative to one another in a direction substantially along the transverse axis, in response to relative movement of the first and second structural component.

Preferably, the web plates move relative to one another in a direction substantially along the longitudinal axis, in response to relative movement of the first and second structural component.

Preferably, the device further comprises a second array of one or more energy-absorbing elements, wherein said one or more energy absorbing elements are a spring, wherein one or more of said springs may be friction spring, wherein the array has at least two orthogonal dimensions comprising of one or more rows and one or more columns, wherein a total number of said rows and columns is equal to three or more, wherein each row is defined by: one or more energy-absorbing elements distributed along a respective axis parallel to the longitudinal axis, and wherein each column is defined by: one or more energy-absorbing elements distributed along a respective axis orthogonal to the longitudinal axis.

Preferably, the one or more energy-absorbing elements of the second array provide a centering force.

One or more statements as defined above in relation to one aspect of the invention may equally apply to the invention described above in another aspect.

Other aspects of the invention may become apparent from the following description which is given by way of example only and with reference to the accompanying drawings.

In this specification where reference has been made to patent specifications, other external documents, or other sources of information, this is generally for the purpose of providing a context for discussing the features of the invention. Unless specifically stated otherwise, any reference to such external documents is not to be construed as an admission that such documents, or such sources of information, in any jurisdiction, are prior art, or form part of the common general knowledge in the art.

For the purpose of this specification, where method steps are described in sequence, the sequence does not necessarily mean that the steps are to be chronologically ordered in that sequence unless there is no other logical manner of interpreting the sequence.

For purposes of the description hereinafter, the terms “upper”, “lower”, “right”, “left”, “vertical”, “horizontal”, “top”, “bottom”, “lateral”, “longitudinal” and derivatives thereof shall relate to the invention as it is oriented in the drawing figures. However, it is to be understood that the invention may assume various alternative variations, except where expressly specified to the contrary. It is also to be understood that the specific devices illustrated in the attached drawings and described in the following description are simply exemplary embodiments of the invention. Hence, specific dimensions and other physical characteristics related to the embodiments disclosed herein are not to be considered as limiting.

It is acknowledged that the term “comprise” may, under varying jurisdictions, be attributed with either an exclusive or an inclusive meaning. For the purpose of this specification, and unless otherwise noted, the term ‘comprise’ shall have an inclusive meaning, allowing for the inclusion of not only the listed components or elements but also other non-specified components or elements. The terms ‘comprises’ or ‘comprised’ or ‘comprising’ have a similar meaning when used in relation to the apparatus, system or to one or more steps in a method or process.

As used hereinbefore and hereinafter, the term “and/or” means “and” or “or”, or both.

As used hereinbefore and hereinafter, “(s)” following a noun means the plural and/or singular forms of the noun.

As used hereinbefore and hereinafter, the term ‘Fig’ means ‘Figure’.

As used hereinbefore or after, when referring to a structural component of a lateral force-resisting system or lateral force-resisting structure or building or building structure, “structural component” refers to a structural element of a building or building structure, such as a structural wall, a shear wall, a beam, a column, and/or a slab, in which the present invention may directly connect to as an energy dissipation device configured to receive primarily either shear or axial load.

As used hereinbefore or after, when referring to an energy-absorbing element or a deformable element of an energy dissipation device, “energy-absorbing element” or “deformable element” refers to an element that may absorb energy through plastic deformation and/or friction in a shear configuration between two structural components; plastic deformation may include flexural, tensile, or compression deformation.

As used hereinbefore or after, when referring to a flexural dissipator, “flexural dissipator” refers to a type of energy-absorbing element that dissipates or absorbs energy through primarily flexural deformation.

As used hereinbefore or after, when referring to an energy-absorbing unit of an energy dissipation device, “energy-absorbing unit” refers to a set of one or more energy-absorbing elements combined in a face-to-face, side-by-side, nested, serially connected, concentric, a combination thereof, or otherwise combined fashion, wherein the energy-absorbing unit is directly or indirectly connected between two structural components, such that one or more energy-absorbing element of the energy-absorbing unit may be directly connected to only one or more of the other energy-absorbing elements of the energy-absorbing unit.

As used hereinbefore or after, when referring to a web plate of a structural component or energy dissipation device assembly, “web plate” refers to a flange, web, or plate extending from an end or surface of which an energy dissipation device is connecting to the structural component, wherein the web plate provides an area in which energy-absorbing elements may be directly or indirectly connected to such that shear load from a structure is transferred to the energy dissipation device through the web plate such that the orientation of the web plate is parallel to the direction of shear load.

As used hereinbefore or after and unless stated otherwise, when referring to a web plate, end plate, parallel connector, or energy-absorbing element of an energy dissipation device or a structural component of a structure connecting to or secured to or joined to a web plate, end plate, parallel connector, or energy-absorbing element or a structural component of a structure, the word “connected” or “connecting” or “secured” or “securing” or “joined” or “joining” can refer to a mechanical or structural connection or joining or fastening or securing between the two subjects, wherein a load may be transferred between the two, allowing a shear load path between two structural components given configuration of the components for the purpose therein.

As used hereinbefore or after, when referring to an shear or shear-configured energy dissipation device, “shear energy dissipating device”, “shear-configured energy dissipating device”, “shear energy dissipation device”, or “shear-configured dissipation device” refers to an energy dissipation device that is configured to have its web plates move transverse to the longitudinal direction of the energy dissipation device when a structure receives lateral-loading, wherein the longitudinal direction is a direction spanning between and orthogonal to the end plates of the device, where the energy-absorbing elements of the energy dissipation device are also configured to dissipate energy from the relative shear motion of the web plates as they move transverse to the longitudinal direction.

As used hereinbefore or after, when referring to an axial or axially-configured energy dissipation device, “axial energy dissipating device”, “axial energy dissipation device” “axially-configured energy dissipating device” or “axially configured energy dissipation device” refers to an energy dissipation device that is configured to have its web plates move axially along the longitudinal direction of the energy dissipation device, wherein the longitudinal direction is a direction spanning between and orthogonal to the end plates of the device, where the energy-absorbing elements of the energy dissipation device are also configured to dissipate energy from the relative shear motion of the web plates as they move along the longitudinal direction.

When used in the claims and unless stated otherwise, the word ‘for’ is to be interpreted to mean only ‘suitable for’, and not for example, specifically ‘adapted’ or ‘configured’ for the purpose that is stated.

Unless specifically stated otherwise, in this specification, use of the word ‘substantially’ with a term, to define a characterizing feature(s), gets all the benefit (i.e. benefit of any broadening) afforded by the use of the word ‘substantially’, and also includes within its scope the feature(s) being that term exactly, (without broadening). For example, if a feature is described/defined in the present specification as being ‘substantially orthogonal’ then that includes, within its scope, the feature being ‘close’ to orthogonal (in so far the word ‘substantially’ is deemed to broaden the term ‘orthogonal’), and also includes within its scope the feature being ‘exactly’ orthogonal.

### BRIEF DESCRIPTION OF THE DRAWINGS

The invention will now be described by way of example only and with reference to the drawings in which:

FIG. 1: shows perspective view of an energy dissipation device according to one embodiment of the present invention for use as a shear energy dissipation device, the device comprising a plurality of UFPs connected to co-planar web plates.

FIG. 2: shows an elevation view of the embodiment of FIG. 1.

FIG. 3A: shows an elevation view of the embodiment of FIG. 1, with section lines A:A and B:B.

FIG. 3B: shows a section view along AA axis of FIG. 3A.

FIG. 3C: shows a section view along BB axis of FIG. 3A.

FIG. 3D: shows a front and side view of a UFP of the embodiment of FIG. 1.

FIG. 3E: shows a plan view of the embodiment of FIG. 1.

FIG. 4: shows an elevation view of an energy dissipation device according to one embodiment of the present invention for use as a shear energy dissipation device, the device comprising an array of UFPs with 5 columns along the X direction.

FIG. 5A: shows an elevation view of the embodiment of FIG. 1 in a neutral position.

FIG. 5B: shows an elevation view of the embodiment of FIG. 1 with the gap opening.

FIG. 5C: shows an elevation view of the embodiment of FIG. 1 with the gap closing.

FIG. 6A: shows an elevation view of an alternative embodiment of the energy dissipation device of FIG. 1 in a neutral position and with the UFPs fastened to the parallel plates.

FIG. 6B: shows an elevation view of the embodiment of FIG. 6A with the gap opening.

FIG. 6C: shows an elevation view of the embodiment of FIG. 6A with the gap closing.

FIG. 7: shows an elevation view of an energy dissipation device according to one embodiment of the present invention for use as a shear energy dissipation device, wherein the array of energy-absorbing elements comprise UFPs and springs.

FIG. 8A: shows an elevation view of an energy dissipation device according to one embodiment of the invention for use as a shear energy dissipation device with parallel offset web plates, and energy-absorbing elements including UFPs and a spring.

FIG. 8B: shows a section view along A:A axis of the embodiment of FIG. 8A.

FIG. 8C: shows a section view along B:B axis of the embodiment of FIG. 8A.

FIG. 9A: shows an elevation view of an energy dissipation device according to one embodiment of the invention for use as a shear energy dissipation device, with parallel offset web plates, and an array of UFPs as energy-absorbing elements.

FIG. 9B: shows a section view along AA axis of the embodiment of FIG. 9A.

FIG. 9C: shows a plan view of the embodiment of FIG. 9A.

FIG. 9D: shows a front view and a side view of a UFP of the embodiment of FIG. 9A.

FIG. 10A: shows an elevation view of an energy dissipation device according to one embodiment of the invention for use as a shear energy dissipation device, with parallel offset web plates, and an array of friction springs as energy-absorbing elements.

FIG. 10B: shows a section view along AA axis of the embodiment of FIG. 10A.

FIG. 10C: shows a friction spring of the embodiment of FIG. 10A.

FIG. 10D: shows a plan view of the embodiment of FIG. 10A.

FIG. 11: shows an elevation view of the embodiment of FIG. 10A.

FIG. 12A: shows an elevation view of an energy dissipation device according to one embodiment of the invention for use as a shear energy dissipation device, with parallel offset web plates, two connected to the left end plate, and one connected to the right end plate, and an array of UFPs between the web plates as energy-absorbing elements.

FIG. 12B: shows a section view along AA axis of the embodiment of FIG. 12A.

FIG. 13A: shows an elevation view of an energy dissipation device according to one embodiment of the invention for use as a shear energy dissipation device, with parallel offset web plates, one connected to the left end plate, and two connected to the right end plate, and an array of friction springs between the web plates as energy-absorbing elements.

FIG. 13B: shows a section view along AA axis of the embodiment of FIG. 13A.

FIG. 13C: shows a plan view of the embodiment of FIG. 13A.

FIG. 14A: shows an elevation view of an energy dissipation device according to one embodiment of the invention for use as a shear energy dissipation device, with parallel offset web plates, one connected to the left end plate, and two connected to the right end, and an array of friction springs and array of UFPs between the web plates as energy-absorbing elements.

FIG. 14B: shows a plan view of the embodiment of FIG. 14A.

FIG. 14C: shows a section view along A:A axis of the embodiment of FIG. 14A.

FIG. 14D: shows a section view along B:B axis of the embodiment of FIG. 14A.

FIG. 15: shows an elevation view of an energy dissipation device according to a preferred embodiment of the invention for use as a shear energy dissipation device, installed within an eccentric braced frame (EBF).

FIG. 16: shows a perspective zoomed view of the energy dissipation device of the embodiment of FIG. 15.

FIG. 17A: shows an elevation view of a UFP according to one example of the present invention.

FIG. 17B: shows an energy-absorbing unit according to one example of the present invention comprising of two UFPs in a side-by-side configuration.

FIG. 17C: shows an energy-absorbing unit according to one example of the present invention comprising of three UFPs in a side-by-side configuration.

FIG. 17D: shows an energy-absorbing unit according to one example of the present invention comprising of two UFPs in a side-by-side configuration and positioned within a larger UFP.

FIG. 17E: shows an energy-absorbing unit according to one example of the present invention comprising of two UFPs in a concentric configuration.

FIG. 17F: shows an energy-absorbing unit according to one example of the present invention comprising of two UFPs in a face-to-face configuration forming a pill shape side-by-side with another two UFPs in a face-to-face configuration forming a pill shape.

FIG. 18A: shows an elevation view of an energy dissipation device according to a preferred embodiment of the invention for use as a shear energy dissipation device, positioned between two shear walls.

FIG. 18B: shows an elevation view of an energy dissipation device according to a preferred embodiment of the invention, positioned between two moment resisting frames.

FIG. 19A: shows an elevation view of an energy dissipation device according to a preferred embodiment of the invention for use as an axial energy dissipation device, the device comprising an array of UFPs and springs connected to co-planar web plates.

FIG. 19B: shows a section view along CC axis of FIG. 19A.

FIG. 19C: shows a section view along AA axis of FIG. 19A.

FIG. 19D: shows a section view along BB axis of FIG. 19A.

FIG. 20: shows an elevation view of an energy dissipation device according toa preferred embodiment for use as an axial energy dissipation device, the device comprising two energy dissipation devices within a rocking wall system between a rocking wall and a slab.

FIG. 21: shows an elevation view of an energy dissipation device for use as an axial energy dissipation device according to a preferred embodiment, at an end of a diagonal brace within a braced frame.

FIG. 22: shows an energy dissipation device according to an alternative embodiment of the invention for use as a shear energy dissipation device, comprising an asymmetrical arrangement of energy-absorbing elements.

FIG. 23: shows an energy dissipation device according to an alternative embodiment of the invention for use as a shear energy dissipation device, comprising an even number of columns of energy-absorbing elements.

FIG. 24: shows an energy dissipation device according to an alternative embodiment of the invention, comprising an array of UFPs connecting to parallel connectors with an expansion gap therein.

### DETAILED DESCRIPTION

It is desirable to have a reliable, sustainable, reversible, reusable, easily manufacturable, durable, efficient, cost-effective, and resilient structural and seismic solution to address the above issues and dissipates energy when subjected to shear loading. Energy dissipation device of the present invention can be referred to as a No-Damage energy dissipation device or energy-dissipation device. This device can cost-effectively be protected against fire or corrosion for various fire rating or durability requirements without compromising structural or seismic performance.

### Energy Dissipation Device

An energy dissipation device (may be referred to as a no damage energy dissipation device as it may be useful for design of a no damage structural system) of the present invention is preferably employed in a lateral force-resisting structure, such as an eccentrically braced frame, shear wall, linked column frame or moment frame, and couples between two load-bearing, or force-resisting, structures thereof (between horizontal beams, for example). The energy dissipation device may be arranged to absorb or dissipate energy generated by relative shear movement of the structures or structural components therein. Such shear movement may be a result of lateral forces on the overall structure, which may occur during seismic events or due to wind. Alternatively, in some embodiments, the energy dissipation device may be arranged to absorb or dissipate energy generated by relative axial movement of the structures or structural components therein, as described in embodiments in following sections. Such axial movement may be a result of lateral forces on the overall structure, which may occur during seismic events of due to wind.

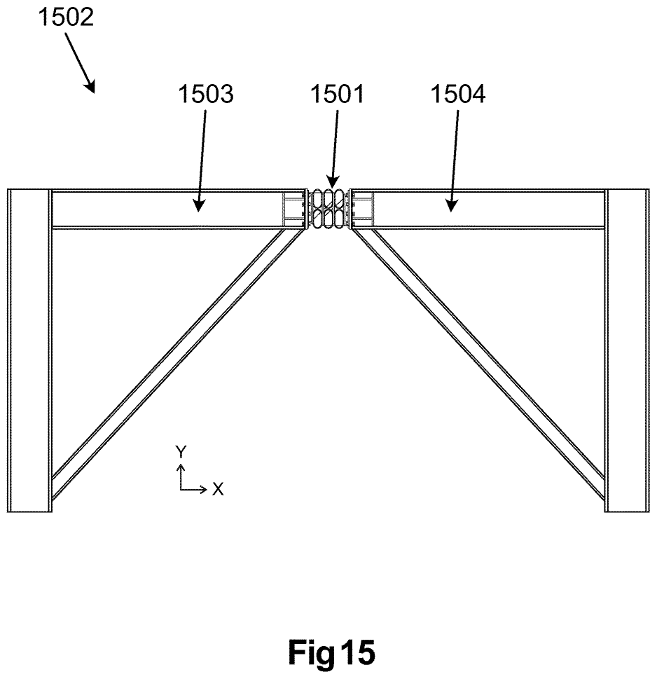

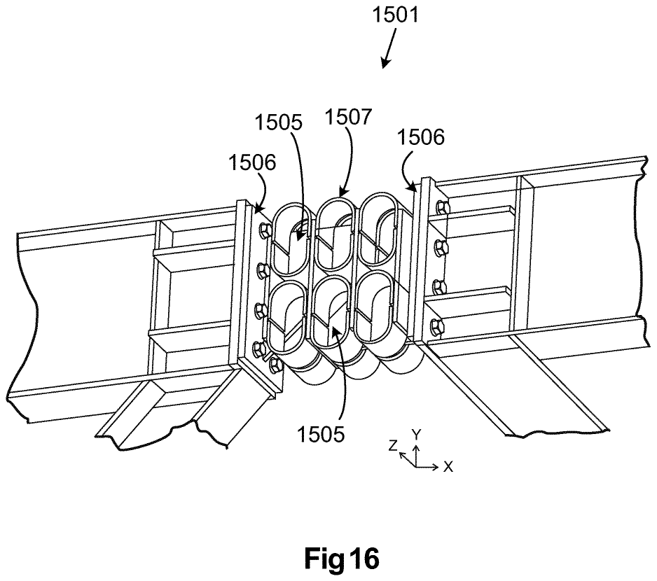

Referring to FIGS. 15 and 16, a preferred embodiment of the invention is shown, where an energy dissipation device 1501 is integrated within an Eccentric-Braced Frame (EBF) 1502, which is a form of braced beam, with the energy dissipation device at the midspan of a beam made up of a first structural component 1503 and a second structural component 1504, connected via web plates 1505 therein. This is just one example, and the skilled person will appreciate that the same principles apply to various lateral force-resisting structures and other building structures besides.

The energy dissipation device extends generally along a longitudinal axis X to span a gap between the beams of the frame. The longitudinal axis X (otherwise referred to as a longitudinal direction) is horizontal in this example, and therefore parallel to expected lateral forces, and substantially perpendicular to the resulting shear movement of the beams. In other examples (one of which is discussed below), the energy dissipation device may be orientated differently accordingly to the particular requirements of the arrangement in which it is employed (for example, the energy dissipation device may be used vertically between a structure and a foundation or between a slab and a wall), and as when oriented horizontally, when vertically oriented energy dissipation device may be configured to receive the laterally originating forces through shear movement substantially orthogonal (along a transverse direction or transverse axis of the device) to the longitudinal axis of the device, or through axial movement substantially along the longitudinal axis of the device.

A pair of end plates 1506 is provided at either end of the energy dissipation device for securing the energy dissipation device to the adjacent structures. The end plates may be a flanged plate having apertures for receiving bolts or screws, for example. This is one example and other suitable means for securing the energy dissipation device to a structure will be apparent to the skilled person.

The gap between the end plates is spanned discontinuously by at least two web plates 1505, each extending from a respective end plate 1506 in a direction parallel to the longitudinal axis X. The web plates are fixed to the end plates and therefore respond to relative shear movement of the beams by moving transversely (vertically, in this example).

The web plates together define an element similar to the web of an I-beam or like of a traditional energy dissipation device, except that in the present case the web is discontinuous, i.e., comprises at least two separate parts separated by a gap such that the parts capable of moving relative to one another. Hence, unlike traditional energy dissipation devices, the web plates are not the primary energy-absorbing component. Instead, the web plates support an array of energy-absorbing elements in the gap between the beams and transfer shear load from the structure to deform the energy-absorbing elements that dissipate some of the associated energy.

Despite the aforementioned discontinuity, the web plates nonetheless overlap (in a spaced apart manner) such that either when viewed from the side, or alternatively when viewed from the top, the plates appear to together span the gap between end plates. The particular arrangements are discussed in more detail below.

As mentioned, the web plates of the present invention do not provide the primary means for energy dissipation and this function is instead provided by an array of energy-absorbing elements 1507. The array is supported by the web plates and couples therebetween.

Each energy-absorbing element 1507 of the array is arranged to deform in response to transverse (shear) movement of the web plates to absorb and dissipate energy. The energy absorber may be a flexural dissipator, hysteretic damper, yield damper, or the like, or a tension-compression friction spring, or a combination of two or more such devices. In alternative embodiments, as mentioned in other sections, it may be preferable that the energy-absorbing elements of the array are arranged to deform in response to longitudinal (axial) movement of the web plates to dissipate energy.

In alternative preferred embodiments, it may be preferable that the energy dissipation device as described is positioned between other structural elements, such as a pair of shear walls 1801 1802, wherein the end plates of the energy dissipation device are fastened to each shear wall, or a pair of moment resisting frames 1803 1804, wherein the end plates of the energy dissipation device are fastened to between adjacent columns 1805 1806, inline with beams 1807 1808 of the moment resisting frames. In some embodiments, such as an implementation of an energy dissipation device with steel walls or steel-concrete shear walls, the end plate may not be required and the energy dissipation device may be directly connected to steel plate of the walls using cleat plates or other type of connections, and said cleat plates may form one or more web plates of the device.

### UFPs

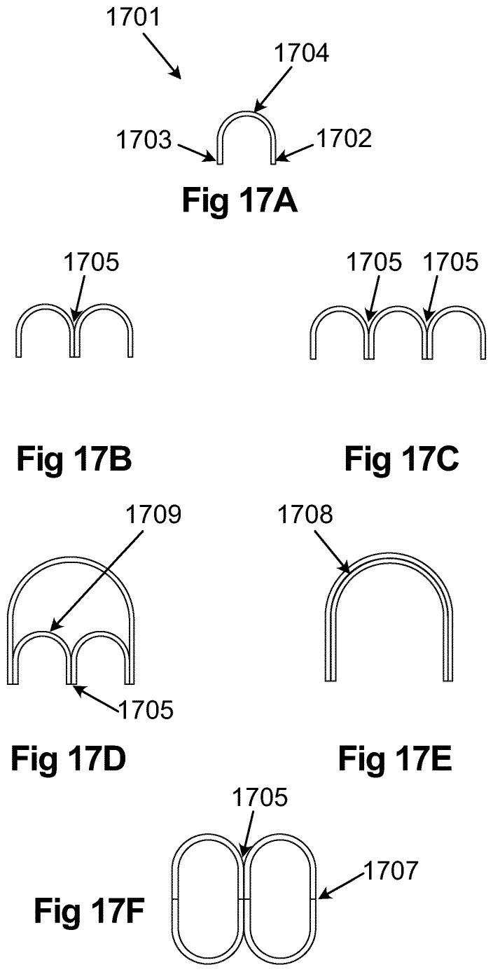

One preferred energy-absorbing element (otherwise referred to as a deformable element) is a type of flexural dissipator know as a U-shaped flexural plate, or UFP, an example of which is shown in FIG. 17A.

UFPs may be formed from strips cut from a sheet of material, such as steel, and bent (out of plane) around a fixed radius. The resulting form is the U-shape plate 1701 seen in FIG. 17A, comprising of two substantially parallel legs 1702 1703 connected by a bent portion 1704 (preferably a semi-circular section).

UFPs can dissipate energy via plastic deformation and provide an easily replaceable and cost-effective solution. However, UFPs also have the advantageous property that, for a particular mode of deformation, the UFP can deform without experiencing strain hardening, or at least with reduced tendency for strain hardening within a particular operational range. Namely, when the legs 1702 1703 of the UFP are subject to relative shear movement in directions parallel the projection of the legs 1702 1703, the bent portion 1704 rolls along the UFP such that the yield point of the UFP moves under increasing displacement rather than increasing deformation at a particular point. This ability provides an energy absorber that is resiliently flexible, wherein resiliently flexible refers to capability of energy-absorbing elements to resist many loading (displacement) cycles without rupture and/or fracture.

In the present invention, UFPs are arranged such that movement of the first and second structural components primarily causes this mode of deformation (i.e., rolling of the bent portion 1704 along the UFP), through relative shear movement between the legs of the UFP.

With this arrangement, the overstrength factor of lateral force-resisting structures employing the present energy dissipation device can be less than that for the traditional or replaceable energy dissipation device. Additionally, UFPs may be less susceptible to low cycle fatigue fracture and can accommodate large displacement demand. Thus, by employing UFPs the present invention can enhance building and structural resilience.

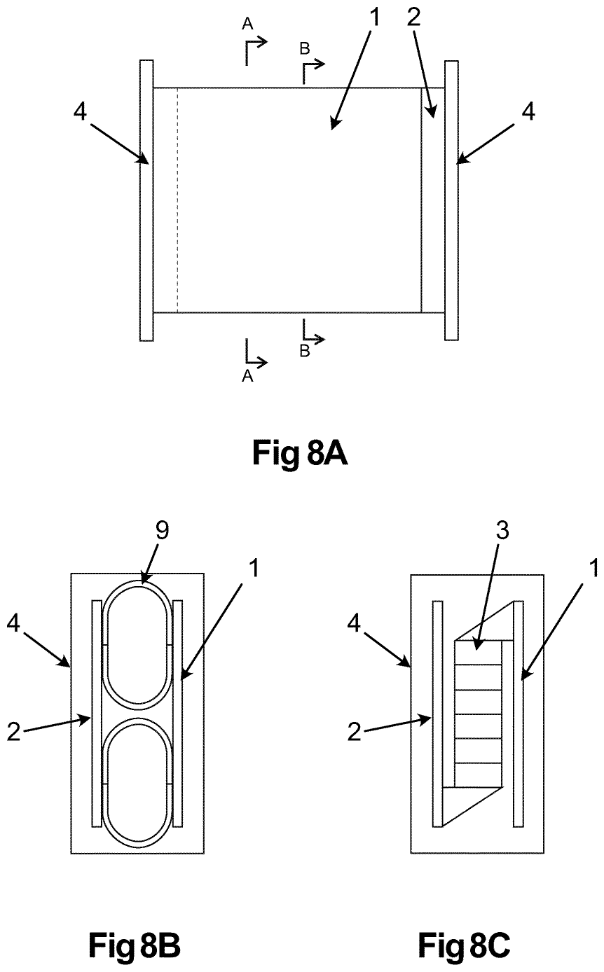

The skilled person may be aware of other dissipators that provide some or all of the same properties. For example, a tension-compression friction spring may be configured to function in a way that avoids or reduces strain hardening and can operate effectively over multiple extension and compression cycles. One of the main functions of Tension-compression friction springs is self-centering capability; as it is a spring that also dissipate energy, when it is under tension or compression displacement the device provides a force to come back to an original position during a lateral load event. One example of the invention employing tension-compression friction springs 3 is shown in FIG. 8C.

The energy-absorbing elements of an array (e.g., UFPs) may or may not all have the same dimensions, thickness, and radius or comprise the same material. Additionally, in some examples, each energy absorbing element comprises more than one UFP, referred to as a collective UFP or more generally an energy absorbing unit. This is discussed in more detail below with respect to FIGS. 17B-F.

An array of energy-absorbing elements of the present invention may comprise of at least one dimension and is preferably an array of at least two dimensions, more preferably a three-dimensional array.

Referring to an example array of energy-absorbing elements of an energy dissipation device, wherein the elements are UFPs, the definitions of the dimensions that make up that are now discussed. A first dimension X of the array extends parallel to a longitudinal axis generally defined by a direction from a left end plate and a second end plate of the energy dissipation device, and is the dimension that defines the length of the array. The length of the X dimension of the array is generally defined as the number of columns of energy-absorbing elements in series along (otherwise referring to being distributed along)the X dimension. A second dimension Y of the array extends vertically and orthogonal to the aforementioned longitudinal axis of the energy dissipation device and is the dimension that defines the height of the array. The length of the Y dimension of the array is generally defined as the number of rows of energy-absorbing elements in series along the Y dimension, The height of each column along the X dimension is equal to the length of the Y dimension (otherwise defined as the number of rows in series along the Y dimension, as previously mentioned). The length of each row along the Y dimension is equal to the length of the X dimension (otherwise defined as the number of columns in series along the X dimension, as previously mentioned). A third dimension Z of the array extends horizontally and orthogonal to the aforementioned longitudinal axis of the energy dissipation device and is the dimension that defines the width of the array. The length of the Z dimension of the array is generally defined as the number of columns of energy-absorbing elements in series along the Z dimension, The length of each column along the Z dimension is equal to the length of the Y dimension (otherwise defined as the number of rows in series along the Y dimension, as previously mentioned). As is apparent from the definition of array dimensions as described, the unit of measure for length of a dimension may be seen as an energy-absorbing element.

In alternative embodiments, an energy dissipation device may comprise a mix of different types of energy-absorbing elements, such as UFPs and springs, wherein different types of energy-absorbing elements may comprise substantially different sizes, or energy-absorbing articles of the same type may even vary in size, such that, for example, a plurality of a first type of energy-absorbing element may form a column along with a length of 3 rows, whereas a second type of energy-absorbing element may form a column with one of said second type of energy-absorbing element that comprises a height that equal to 3 rows of the first type of energy-absorbing article; defining dimension lengths of arrays with mixed energy-absorbing elements may preferably default to the smallest energy-absorbing element as the reference unit of measure in length, or alternatively it may be preferable to refer to each type of energy-absorbing element as part of separate arrays restricted to energy-absorbing elements of the same type, relying on further description when referencing particular rows/columns as rows and columns between the arrays may be intermixed.

In alternative embodiment, it may be preferable that an energy dissipation device comprises an array of energy-absorbing elements wherein one or more row or column along a dimension of the array comprises a number of energy-absorbing elements different to that of another row or column in the same dimension. The row/columns in that dimension may comprise energy-absorbing of the same size, exclusively different sizes, or of mixed sizes, but comprise a number of energy-absorbing elements different to each other.

In alternative embodiments, it may be preferable to use names such as row, column, stack, layer, or other descriptors, wherein the pairing of each of the aforementioned dimensions X, Y, Z may comprise different names than previously used to refer to the length of said dimensions. It should be understood that the use of row, column, or otherwise for each dimension is inconsequential to the arrangement and intricacies of arrays of energy-absorbing articles, and the importance of nomenclature should be that within each embodiment as discussed therein exists a stable usage of terminology for said embodiment,

With this arrangement, the length of the energy dissipation device along the longitudinal axis can be modified by changing the number of energy absorbing elements in the array without significantly affecting the properties or operation of individual energy absorbing elements.

This can provide a marked difference over prior art solutions, which are generally only effective (i.e., deflect and deform as intended) over a limited length range. For example, a traditional energy dissipation device, such as an I-beam, may change its mode of deflection from shear to flexural beyond a certain length. This can place design restrictions on lateral force-resisting structures and other structures, in particular the distance between those structures.

Preferably, each energy-absorbing element of a row along is aligned along the first axis and is also rotationally aligned (i.e., having the same orientation), such that each energy absorbing element has the same configuration and can be secured in the same way.

Preferably, each energy absorbing element are oriented such that the legs of the UFP are parallel to a plane along the longitudinal axis, such that the direction of flexural dimension is along the same direction, providing effective dissipation of shear load across the energy dissipation device.

In the case of the energy absorbing element being a single UFP, each leg of the UFP is secured (e.g., fixed using a fastener) to a respective web member, either directly or indirectly via an intermediate member, such that the legs displace to cause the desired mode of deformation discussed above in response to shear movement of the web members.

In addition to providing control over the length of the energy dissipation device, the number of energy absorbing elements can also provide control over the capacity of the energy dissipation device (i.e., energy dissipative, damping, or force-resistive capacity). For example, increasing the number of energy absorbing units can increase the capacity of the energy dissipation device. Additionally, increasing thickness and width of UFPs will increase energy dissipation capacities and stiffness of the energy dissipation device. Thickness of UFPs will significantly increase the stiffness without significantly increasing the cost. So, we can increase building stiffness with minimal building cost increase and material use.

To provide yet further control over the capacity of the energy dissipation device for a given length, the array of energy absorbing elements preferably comprises at least a second dimension. The second dimension may be the dimension Y defining the height of array.

For example, the array may comprise a second plurality of energy absorbing elements aligned along a second axis in parallel with the first plurality (and parallel to the longitudinal axis A). The second plurality of energy absorbing elements may be a second row, for example, and above/below or beside the first row.

The third dimension may be the dimension Z in FIG. 15 (out of the page) may define the thickness of the array.

The array of energy absorbing elements, and its arrangement with the discontinuous web members, is configured taking into consideration a number of factors that the present inventor has recognised.

Some or all of these advantages may be achieved by the present invention, and the association between particular features and corresponding advantages will be evident from the following discussion.

### Energy Dissipation Device Configuration—Co-Planar Web Plates

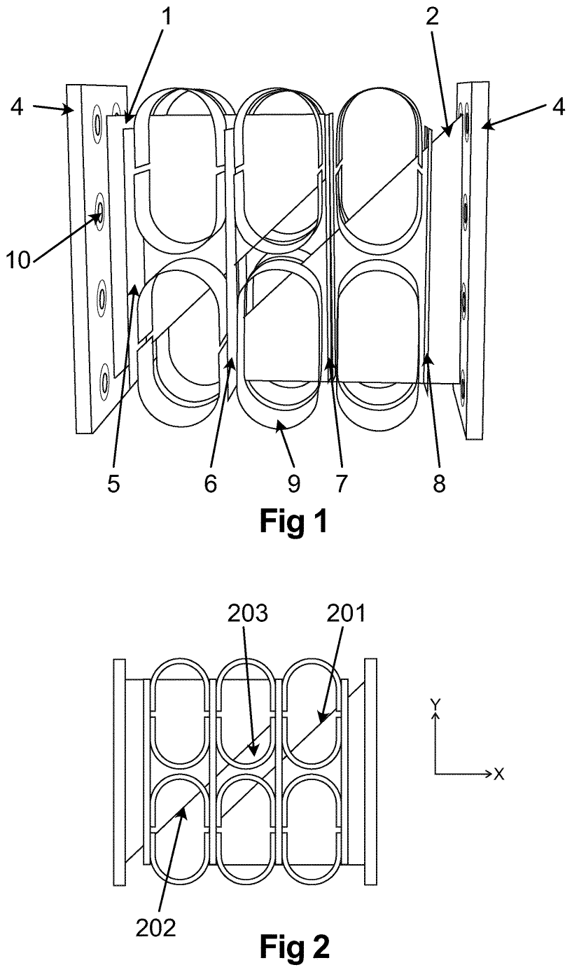

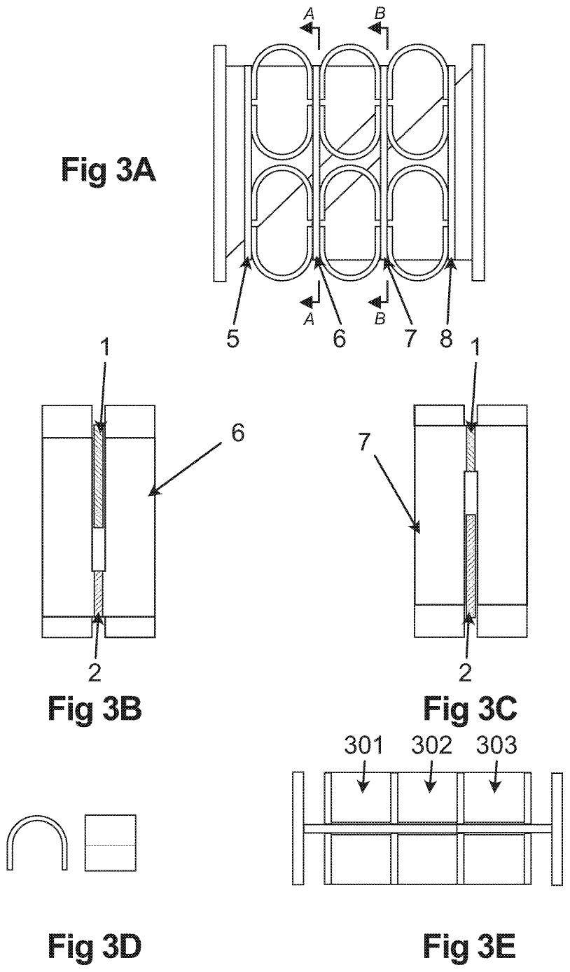

Referring to FIGS. 1 to 3 and 5A-C an embodiment of the invention is shown, wherein an energy dissipation device comprises a variable cross section web plate 1 and a web plate 2 which are connected to endplates 4. FIG. 1 shows a type of flexural dissipator known as a U-shaped flexural plate (UFP). The UFP is an energy-absorbing (i.e., ‘active’) element of the energy dissipation device. A UFP is one preferred example of a suitable part having an energy-absorbing or dissipative function. The energy dissipation device may comprise a plurality of these elements arranged in an array as shown in FIG. 1. The no damage energy dissipation device defining longitudinal axis X, orthogonal to the endplates 4, and the web plate 1 and the web plate 2 are along the axis X, wherein the web plates 1 2 are co-planar to each other. The variable cross section of each web plate forms a taper, wherein the tapered edges 201 202 are substantially parallel. The tapers of each web define a diagonal gap 203 between the free-ends of each web plate.

Parallel connectors 5, 6, 7 and 8 may be connected to either web plate 1 or web plate 2. The parallel connectors may be a weld plate. Distributed along longitudinal axis X of the energy dissipation device, in the present embodiment, the parallel connectors 5 and 7 are connected to the web plate 1 and the parallel connectors 6 and 8 are connected to the web plate 2 respectively. Connected to both sides of the web plate 1 and the web plate 2, parallel connectors may have either identical or unequal spacing along longitudinal axis X of the energy dissipation device. Parallel connectors may have either identical or unequal length along perpendicular to X direction. The energy dissipation device can be connected to other elements of a structure through bolted, welded, or other types of connections. Three dimensionally distributed UFPs 9 are connected to parallel connectors 5, 6, 7 and 8 using welded 501, bolted 601, or other types of connections. When a structure, for example an eccentric braced frame (refer to FIG. 15), is subjected to seismic or wind loading the web plate 1 and the web plate 2 are subjected to shear loads. The web plate 1 and the web plate 2 are separated along the axis x by the diagonal gap 203 such that the gap allows the web plates to move transversally when subjected to shear loads. Under shear loading, the web plates 1 and the web plates 2 move transversally, but in opposite directions, such that the gap 203 opening 502 or closing 503, and UFPs 9 flex to dissipate wind or seismic or other excitation energy. The UFPs 9 may or may not all have the same dimensions, thickness, and radius or comprise the same material.

In preferred embodiments, the gap between the first and second web plates is selected such that the web plates remain non-contacting under design-level displacement, whereby energy dissipation and system stiffness are primarily governed by deformation of the U-shaped flexural plates (UFPs). Upon displacement exceeding this level, the gap closes and the web plates engage, enabling additional load transfer and a substantial increase in stiffness and load-carrying capacity, together with secondary energy dissipation through yielding of the web plates. This dual-stage response provides increased capacity, stiffness, redundancy, and robustness under extreme loading conditions.

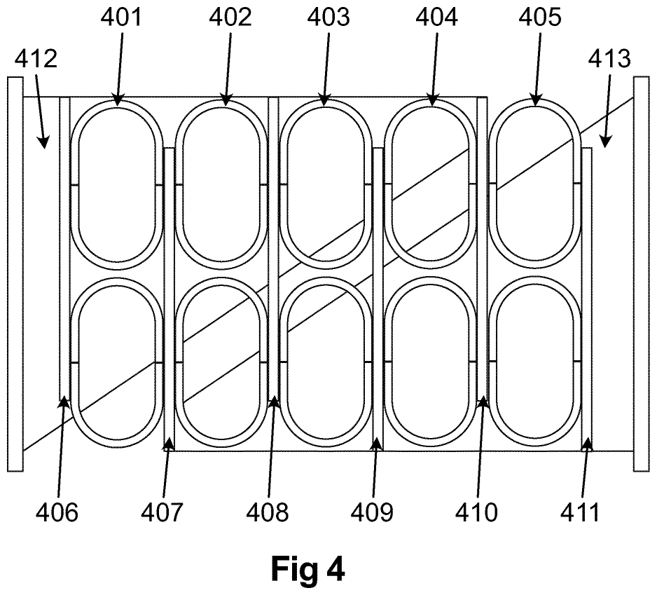

The energy dissipation device comprises the array of UFPs 9 arranged in three vertical columns 203 204 205 along an X dimension, two columns along a Z direction, and four rows along a Y dimension, wherein the UFPs are connected to the parallel connectors 5 6 7 8 located on both sides of the web plates. FIG. 4 shows an alternate configuration of the embodiment wherein the array of UFPs comprises five vertical columns 401 402 403 404 405 along an X dimension connected to parallel connectors 406 407 408 409 410 411 located on both sides of web plates 412 413. Unlike traditional or replaceable energy dissipation devices, the energy dissipation device has no substantial length limitation. Thus, the energy dissipation device can have a wide variety of lengths and arrays of UFPs with a wide variety of numbers of vertical columns of UFPs connected to the parallel connectors without compromising functionality or performance. The UFPs can be seen to be connected to successive parallel connectors, wherein the parallel connectors are alternatingly connected/secured to web plates such that each UFP is indirectly connected to both web plates. For example, if it is used in EBF structures, the no length limitation characteristic of the energy dissipation device provides architectural flexibility, future reusability, and building transformation capability without compromising structural performance. Reusability and transformation capabilities are aligned with cradle-to-cradle (C2C) sustainability strategy and add sustainability values to buildings and structures. While traditional sustainability (downcycling) tries to reduce environmental footprints, C2C (upcycling or reuse) aims at changing those footprints into positive rather than less negative impacts.

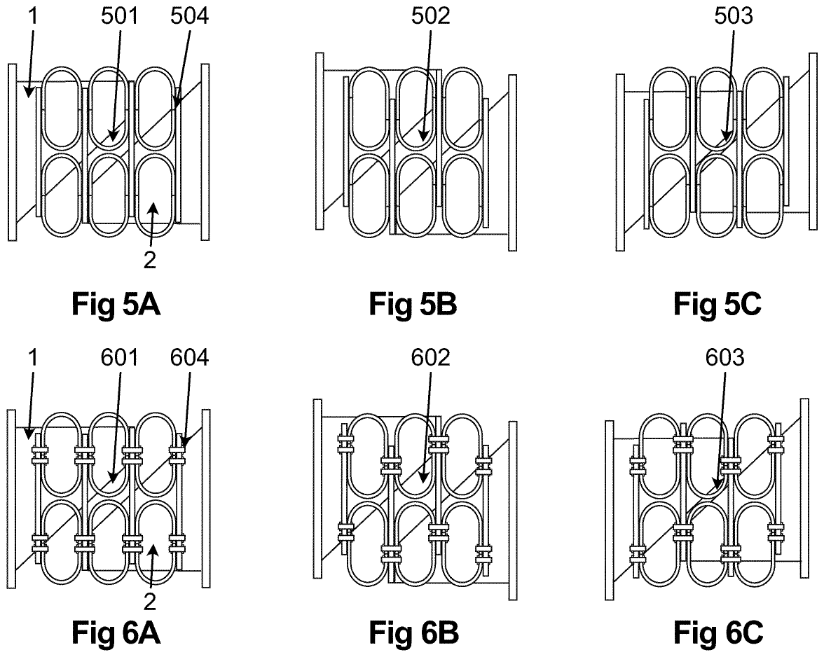

Referring to FIGS. 5A-C and 6A-C, FIGS. 5A-C shows the embodiment of FIGS. 1 to 3 in various positions, and FIGS. 6A-C show an alternative embodiment, equivalent to the embodiment of FIGS. 1 to 3 but alternative method of securing the energy-absorbing elements to the parallel connectors 5 6 7 8. FIGS. 5A and 6A show an undeformed (neutral position) at left, but forces acting on the energy dissipation device may result in extension of the energy dissipation device, causing the gap 203 opening 502 602 shown in FIGS. 5B and 6B in middle. From neutral or extended positions shown in FIGS. 5A-B and 6A-B at left and middle respectively, forces may result in the compression of the energy dissipation device, causing the gap 203 to be closing 503 603 shown in FIGS. 5C and 6C at the right. FIGS. 5A and 6A show undeformed and deformed energy dissipation device with UFPs connected to parallel connectors using welded 504 and bolted 604 connections respectively. As the energy dissipation device is extended or compressed, UFPs connected to the parallel connectors flex to dissipate energy. However, strain hardening likely doesn't occur in UFPs of the energy dissipation device, thus, the overstrength factor for structures with energy dissipation device is less than that for the traditional or replaceable energy dissipation devices. The capacity and stiffness of the energy dissipation device can be customised by altering the number, radius, width, and/or thickness of UFPs. Unlike the majority of low-damage seismic solutions where increasing stiffness results in a significant increase in cost, for the energy dissipation device, rising stiffness may minimally affect the cost. Therefore, the energy dissipation device is a cost-effective, robust, and real no-damage seismic and structural solution.

Unlike traditional and replaceable energy dissipation devices, the energy dissipation device is less susceptible to low cycle fatigue fracture and can accommodate large displacement demand. Thus, the energy dissipation device can enhance building and structural resilience. After a seismic event, the energy dissipation device may return to the neutral position or gap closing or gap opening positions, as shown in FIGS. 5A-C and 6A-C, after multiple extension and compression cycles. If the UFPs have not given in response to a tiny displacement demand or if the energy dissipation device is accidentally self-centred by external inertia forces from the structure, the energy dissipation device will revert to its neutral position.

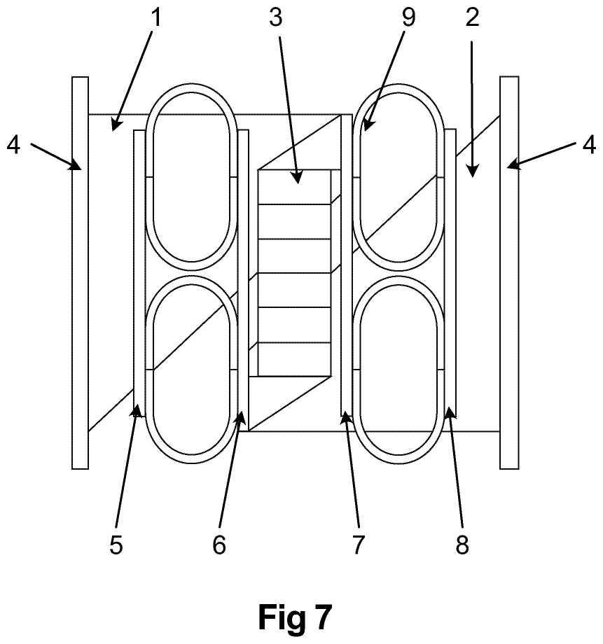

In alternative embodiments, it may be preferable that one or more of the energy-absorbing elements comprise springs or friction springs to dissipate energy and/or to self-centre the energy dissipation device, acting as a resilient biaser to urge the web plates into a predetermined relative transverse position. Resiliency of an energy dissipation device refers to capability to resist many loading (displacement) cycles without rupture and/or fracture. For example, referring now to FIG. 7, an alternative embodiment of the invention is shown providing an energy dissipation device with a spring 3 in combination with UFP-based energy-absorbing elements 9, which may in some circumstances provide a preferable embodiment wherein the UFP energy-absorbing elements 9 perform the majority of energy dissipation, whereas the spring 3 performs an additional measure of self-centring the connected structural components. As show, it is preferably that the location of this biasing spring is in the positioned centrally along the longitudinal axis of the energy dissipation device. The energy dissipation device comprises end plates 4 at either end, with co-planar web plates 1 2, wherein the UFPs 9 are mounted to parallel connectors 5 6 7 8, with the spring 3 in the centre of the energy dissipation device, mounted between the parallel connectors 6 7. The plates 5 7 are mounted to the web plate 1 and the plates 6 8 are mounted to the web plate 2. After the seismic event, tension-compression friction springs or other types of springs can assist the NDSL with returning to the neutral position. In a further example, providing a friction spring as the energy dissipation mechanism for a majority of the energy-absorbing elements may be preferable, wherein energy is dissipated through friction, rather than flexural deformation.

For the embodiment shown in FIGS. 1 to 3, an odd number of columns of energy-absorbing elements in the X direction is provided that connect to an even number of parallel connectors to avoid unbalanced loading (resulting in a moment force) due to asymmetric distribution of UFPs. In some embodiments, it may be preferable that the number of energy-absorbing elements in each row along a longitudinal axis (or otherwise defined by the number of columns along the longitudinal axis) is an odd number and the number of parallel connectors that the energy-absorbing elements are connected to therein is an even number, preferably a number equal to the number of energy-absorbing elements in each row-plus one, resulting in a substantially balanced shear load across the parallel connectors and web plates. However, in alternative embodiments, the energy dissipation device may comprise an even number of columns in the X direction and still avoid unbalanced loading.

For example, FIG. 23 shows an energy dissipation device with four parallel connectors 2301 2302 2303 2304 alternatingly connected to web plates 1 2. The web plates are each secured to one of the end plates 4 of the device. The energy dissipation device as shown could feasibly receive three columns of energy-absorbing elements, but is instead configured with two columns of UFPs 9 symmetrically arranged on either side of its centre. This may provide a column that may receive energy-absorbing elements at a later period, or the centre region of the energy dissipation device may be used for other elements of the building, such as building services, facades, sensors, thermal insulation, or fire insulation.

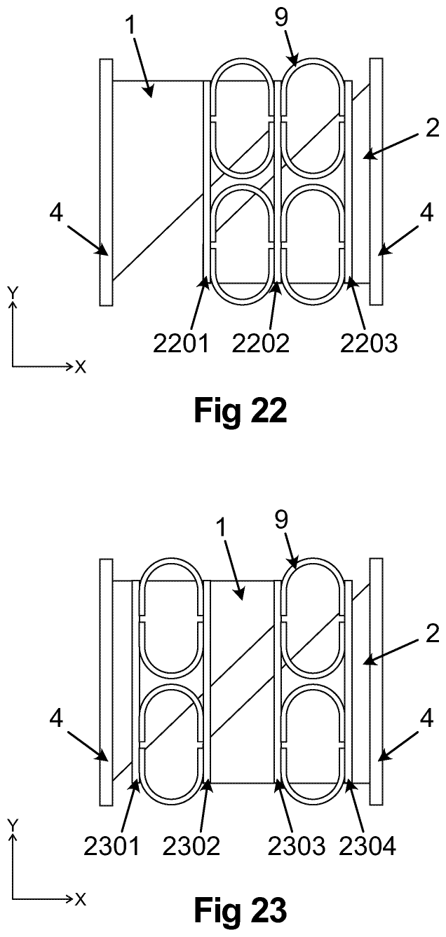

In alternative embodiments, it may be required or preferable that the energy dissipation device may comprise an even number of columns in the X direction that result in unbalanced loading. For example, referring to FIG. 22 an energy dissipation device with an array of energy-absorbing elements with two columns of UFPs 9 connected to three parallel connectors 2201 2202 2203. The web plates are each secured to one of the end plates 4 of the device and the parallel connectors are alternatingly connected to web plates 1 2, resulting in unbalanced loading across the energy dissipation device. Although this configuration is generally not preferable, it still performs energy dissipation and later-force resisting structures are often designed with unbalanced loads when required, thus, in some embodiments, an energy dissipation device as shown in FIG. 22 may be viable and preferable, and remaining unused space within the device may be used for other elements of the building, such as building services, facades, sensors, thermal insulation, or fire insulation.

In alternative embodiments it may be preferable that each web plate of the energy dissipation device comprise a balanced number of UFPs connected to said web plate on either side, or a alternatively, a number of UFPs on one side that comprise a total strength and/or stiffness to a number of UFPs on the other side of the web plate, such that the resulting torsional load, torsional moment, and/or coupled force on the energy dissipation device is reduced.

### Energy Dissipation Device Configuration—Parallel Offset Web Plates

Referring to FIGS. 8-10, an alternative embodiment of the configuration of web plates of the energy dissipation device is shown, wherein the web plates are not co-planar as with previously described embodiments, rather the web plates are parallel but offset in a transverse direction, providing a space between for energy-absorbing elements to be positioned. In preferable embodiments, a plurality of spaces between a plurality of web plates are provided, as discussed further below. In preferable embodiments, the web plates of the energy dissipation device are parallel and offset, wherein an axis orthogonal to the longitudinal axis of the device intersects with each web plate, such that energy-absorbing elements with each space between the web plates has access to a surface facing said space in which the element may directly or indirectly mount to.

Referring to FIGS. 8A-C, an embodiment is shown to include a constant or variable cross-section web plate 1 on the left and web plate 2 on the right side of the energy dissipation device, which are connected to endplates 4 at the left and right respectively. The web plates 1 2 are parallel but offset in a transverse direction, providing a space between for energy-absorbing elements to be positioned. The no-damage energy dissipation device defining longitudinal axis X and web plate 1 and web plate 2 is along the axis X. Refer to FIG. 2 for the direction of axis X. The energy dissipation device can be connected to other elements of a structure using bolted, welded, or other types of connections. A Two-dimensionally distributed array of UFPs 9 are connected to web plate 1 and web plate 2 within the space between the offset web plates using welded, bolted, or other types of connections. Furthermore, the embodiment comprises a spring 3 in the centre of the array. When a structure, for example, an eccentrically braced frame (EBF (refer to FIG. 15)) is subjected to seismic or wind loading, the web plate 1 on the left and web plate 2 on the right side are subjected to shear loads. Web plate 1 and web plate 2 are moveable transversally but in opposite directions when the energy dissipation device is subjected to shear loads, wherein the energy-absorbing elements are configured to dissipate the shear load from relative shear movement of the web plates 1 2. As web plate 1 and web plate 2 are moved transversally, UFPs 9 flex to dissipate wind or seismic or other excitation energy, and the spring 3 assist with returning the energy dissipation device and structural components to a neutral position. The spring 3 may be a tension-compression spring of a friction spring in alternative embodiments.

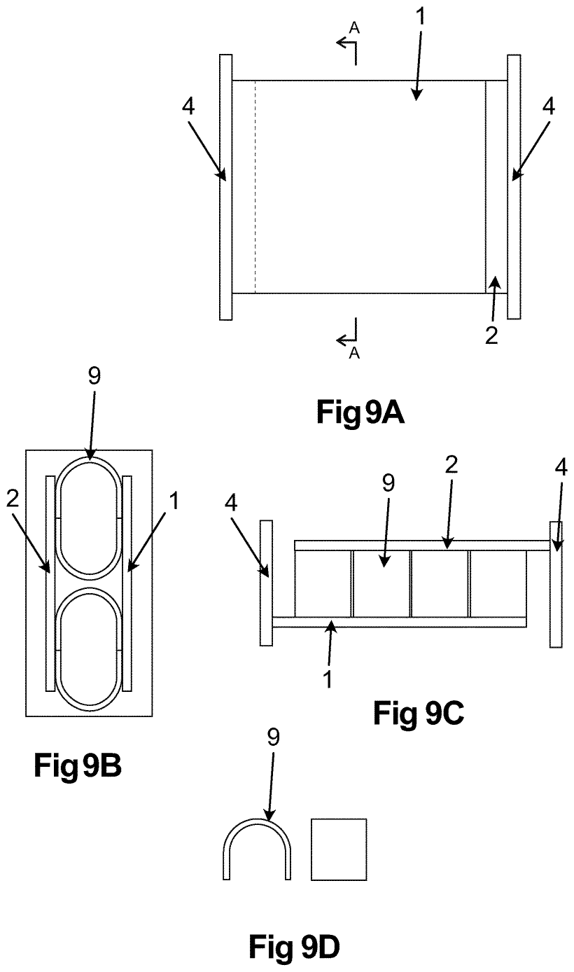

Referring to FIGS. 9A-D, an alternative embodiment of an energy dissipation device is shown with two-dimensionally distributed UFPs 9 connected to web plates 1 2 which are connected to endplates 4 at the left and right respectively. The web plates 1 2 are parallel but offset in a transverse direction, providing a space between for energy-absorbing elements to be positioned. The no-damage energy dissipation device defining longitudinal axis X and web plate 1 and web plate 2 is along the axis X. The energy dissipation device can be connected to other elements of a structure using bolted, welded, or other types of connections. A Two-dimensionally distributed array of UFPs 9 are connected to web plate 1 and web plate 2 within the space between the offset web plates using welded, bolted, or other types of connections. When a structure, for example, an eccentrically braced frame (EBF (refer to FIG. 15)) is subjected to seismic or wind loading, the web plate 1 on the left and web plate 2 on the right side are subjected to shear loads. Web plate 1 and web plate 2 are moveable transversally but in opposite directions when the energy dissipation device is subjected to shear loads, wherein the energy-absorbing elements are configured to dissipate the shear load from relative shear movement of the web plates 1 2. As web plate 1 and web plate 2 are moved transversally, UFPs 9 flex to dissipate wind or seismic or other excitation energy.

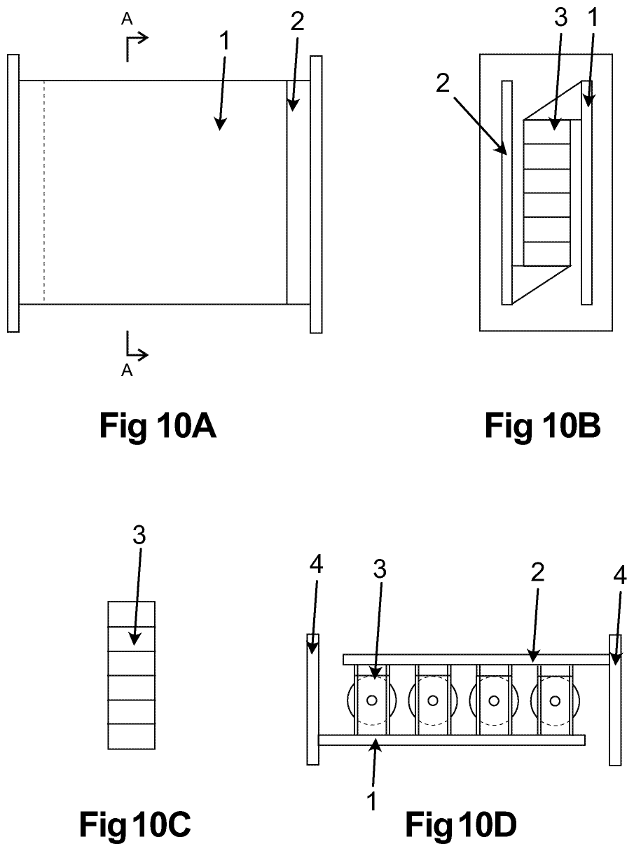

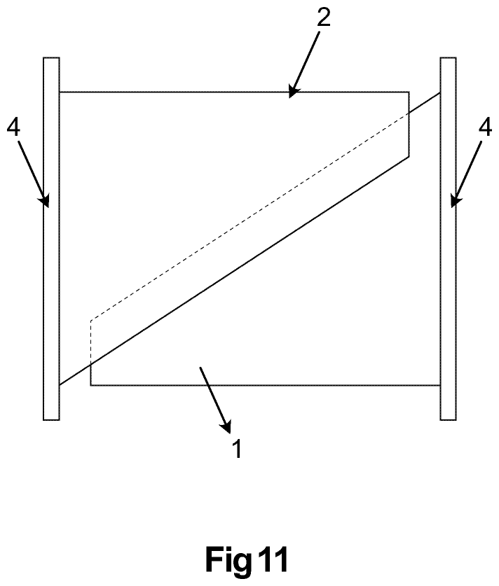

Referring to FIGS. 10A-D and 11, an alternative of an energy dissipation device is shown with an array of energy-absorbing elements mounted between two web plates 1 2, wherein the web plates 1 2 are parallel but offset in a transverse direction, providing a space between for the energy-absorbing elements to be positioned. The array of energy-absorbing elements comprises a row of tension-compression friction springs 3. When a structure, for example, an eccentrically braced frame (EBF (refer to FIG. 15)) is subjected to seismic or wind loading, the web plate 1 on the left and web plate 2 on the right side are subjected to shear loads. Web plate 1 and web plate 2 are moveable transversally but in opposite directions when the energy dissipation device is subjected to shear loads, wherein the energy-absorbing elements are configured to dissipate the shear load from relative shear movement of the web plates 1 2. As web plate 1 and web plate 2 are moved transversally, springs 3 compress/extend to dissipate wind or seismic or other excitation energy.

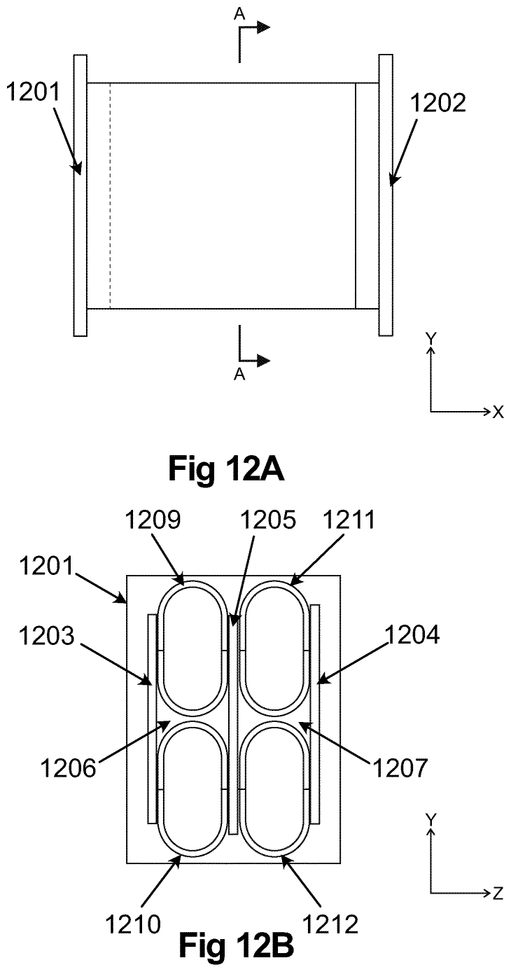

Referring to FIGS. 12A-B, an alternative embodiment of an energy dissipation device is shown with left and right end plates 1201 1202, wherein two outer web plates 1203 1204 are connected to the left end plate 1201 and an inner web plate 1205 is connected to the right end plate 1202. The web plates 1203 1204 1205 are all parallel to each other and offset, providing a first space 1206 between the outer web plate 1203 and the inner web plate 1205 and a second space 1207 between the outer web plate 1204 and the inner web plate 1205. The energy dissipation device comprises an array of energy-absorbing elements, wherein the energy-absorbing elements are UFPs 1209 1210 1211 1212. The array is an array comprising one column in the X direction, four rows in the Y direction, and two columns in the Z direction, wherein the UFPs 1209 1210 of the first column in the Z direction are within the first space 1206 and the UFPs 1211 1212 of the second column in the Z direction are within the second space 1207. When a structure, for example, an eccentrically braced frame (EBF (refer to FIG. 15)) is subjected to seismic or wind loading, the web plate(s) 1203 1204 on the left and web plate(s) 1205 on the right side are subjected to shear loads. The web plate(s) 1203 1204 and web plate(s) 1205 are moveable transversally but in opposite directions when the energy dissipation device is subjected to shear loads, wherein the energy-absorbing elements are configured to dissipate the shear load from relative shear movement between the web plates 1203 1204 and the web plate 1205. As the web plate(s) 1203 1204 and web plate(s) 1205 are moved transversally, UFPs 1209 1210 1211 1212 flex to dissipate wind or seismic or other excitation energy. FIG. 12B shows the elevation and section A-A of the embodiment of the energy dissipation device with UFPs connected to the constant cross-section web plates 1203 1204 on left and the web plate 1205 on the right side of the energy dissipation device.

In alternative embodiments, the number of web plates connected to the left endplate 1201 may be equal to the number of web plates connected to the right endplate 1202, or may be 1 more or 1 less than the number of web plates connected to the right endplate. It is preferable that the number of web plates connected to one end plate is either 1 more or 1 less than the number of web plates connected to the other end plate, providing a balanced load about a longitudinal axis of the energy dissipation device, however alternative embodiments may provide various numbers of web plates connected to a first end plate and are arranged symmetrically about a plane parallel to the web plates and coincident with the longitudinal axis, that interlock with a variable number of web plates connected to a second end plate. In alternative embodiments, it may be preferable that the number of web plates connected to a first end plate of an energy dissipation device is double a number of web plates connected to a second end plate, wherein each of the web plates of the second end plate of the energy dissipation device may fit between every second space between the web plates connected to the first end plate.

In alternative embodiments, Web plate(s) at the left and/or web plate(s) at right side of the energy dissipation device may or may not all have the same dimensions, thickness or comprise the same material.

Furthermore, in alternative embodiments, the dimension of the array of energy-absorbing elements in the X, Y, Z dimensions may vary as preferable for the structural capacity and/or space requirements of the energy dissipation device.

FIGS. 12A-B shows the UFPs 1209 connected to web plates 1203 1204 1205 using welded connections, however in alternative embodiments, other types of connections such as fasteners may be used.

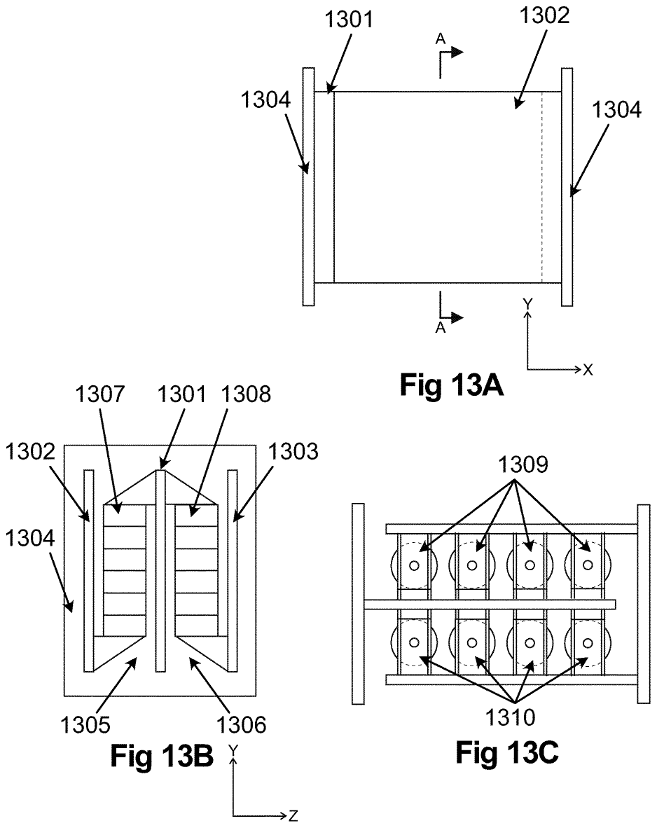

Referring to FIGS. 13A-C, an alternative embodiment is shown with a two-dimensionally distributed array of tension-compression friction springs connected to web plate 1301 and web plates 1302 1303. The web plate 1301 is connected to endplate 4 on the left and the two web plates 1302 1303 are connected to endplate 4 on the right side of the embodiment. The web plates 1301 1302 1303 are all parallel to each other and offset, providing a first space 1305 between the outer web plate 1302 and the inner web plate 1301 and a second space 1306 between the outer web plate 1303 and the inner web plate 1301. The NDSL comprises an array of energy-absorbing elements, wherein the energy-absorbing elements are tension-compression friction springs 1309 1310. The array is an array comprising four columns in the X direction, one row in the Y direction, and two columns 1307 1308 in the Z direction, wherein the springs 1310 of the first column 1307 in the Z direction are within the first space 1305 and the UFPs 1309 of the second column 1308 in the Z direction are within the second space 1306. When a structure, for example, an eccentrically braced frame (EBF (refer to FIG. 15)) is subjected to seismic or wind loading, the web plate 1301 on the left and web plates 1302 1303 on the right side are subjected to shear loads. The web plate 1301 and web plates 1302 1303 are moveable transversally but in opposite directions when the energy dissipation device is subjected to shear loads. As the web plate 1301 and web plates 1302 1303 are moved transversally, springs 1309 1310 elongate/compress to dissipate wind or seismic or other excitation energy.

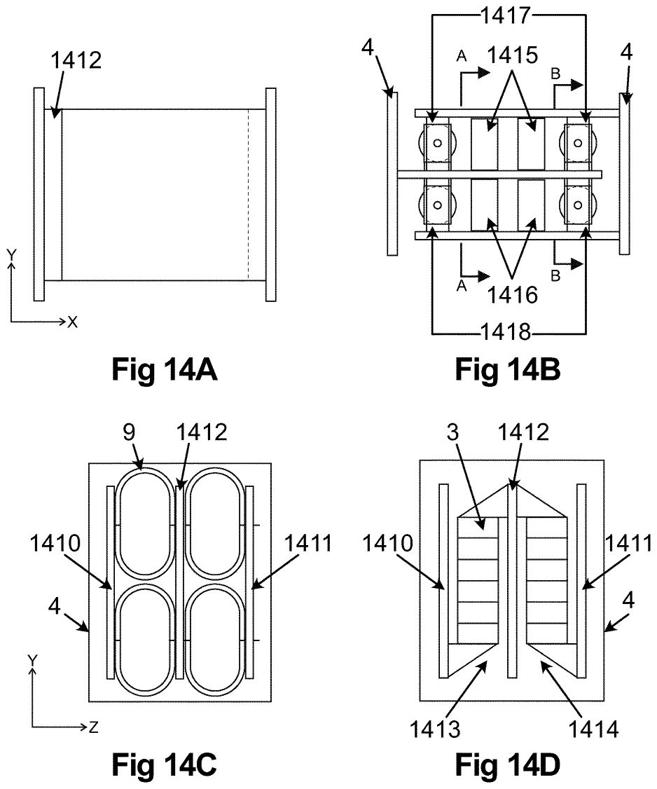

Referring to FIGS. 14A-D, an embodiment is shown to include left and right end plates 4, wherein two outer web plates 1410 1411 are connected to the left end plate and an inner web plate 1412 is connected to the right end plate. The web plates 1410 1411 1412 are all parallel to each other and offset, providing a first space 1413 between the outer web plate 1410 and the inner web plate 1412 and a second space 1414 between the outer web plate 1411 and the inner web plate 1412. The web plates 1410 1411 1412 are parallel but offset in a transverse direction, providing a space between for energy-absorbing elements to be positioned. A Three-dimensionally distributed array of UFPs 9 are connected to web plates 1410 1411 1412 within the spaces 1413 1414 between the offset web plates using welded, bolted, or other types of connections. Furthermore, the embodiment comprises a two-dimensionally distributed array of tension-compression friction springs 3. The UFP array is an array comprising two columns in the X direction, four rows in the Y direction, and two columns in the Z direction, wherein the UFPs 1415 of the first column in the Z direction are within the first space 1413 and the UFPs 1416 of the second column in the Z direction are within the second space 1414. The spring array is an array comprising two columns in the X direction, one row in the Y direction, and two columns in the Z direction, wherein the springs 1417 of the first column in the Z direction are within the first space 1413 and the springs 1418 of the second column in the Z direction are within the second space 1414. When a structure, for example, an eccentrically braced frame (EBF (refer to FIG. 15)) is subjected to seismic or wind loading, the web plate 1412 on the left and web plates 1410 1411 on the right side are subjected to shear loads. Web plate 1412 and web plates 1410 1411 are moveable transversally but in opposite directions when the energy dissipation device is subjected to shear loads, wherein the energy-absorbing elements are configured to dissipate the shear load from relative shear movement between the web plates 1410 1411 and the web plate 1412. As web plate 1412 and web plates 1410 1411 are moved transversally, The UFPs 9 flex to dissipate wind or seismic or other excitation energy, and the springs 3 assist with returning the energy dissipation device and structural components to a neutral position. The spring 3 may also contribute to energy dissipation.

In alternative embodiments, it may be preferable that energy-absorbing elements of an energy dissipation device are configured to dissipate energy from relative shear movement of web plates of an energy dissipation device, wherein the relative shear movement of the web plates are due to the web plates being moveable axially but in opposite directions along a longitudinal axis of an energy dissipation device. For example, the energy dissipation device may be attached to a first structural component and a second structural component of a structure, where when the structure or structural components are subjected to lateral loads, the energy dissipation device is subjected a substantially axial load along its longitudinal axis, where the energy dissipation device may dissipate this axial load through an array of energy-absorbing elements configured to dissipate energy from the resulting relative shear movement of the web plates of the energy dissipation device.

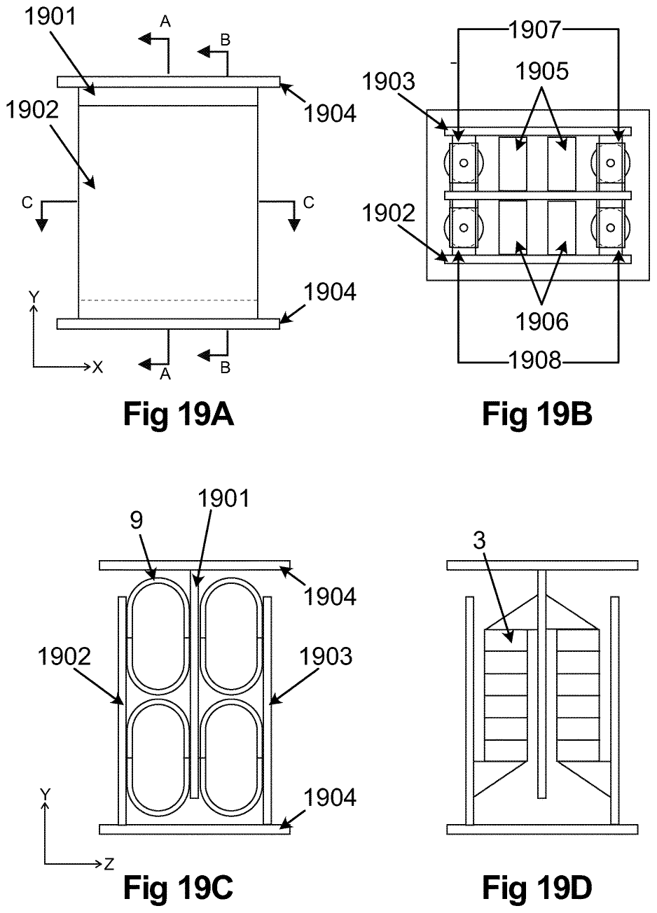

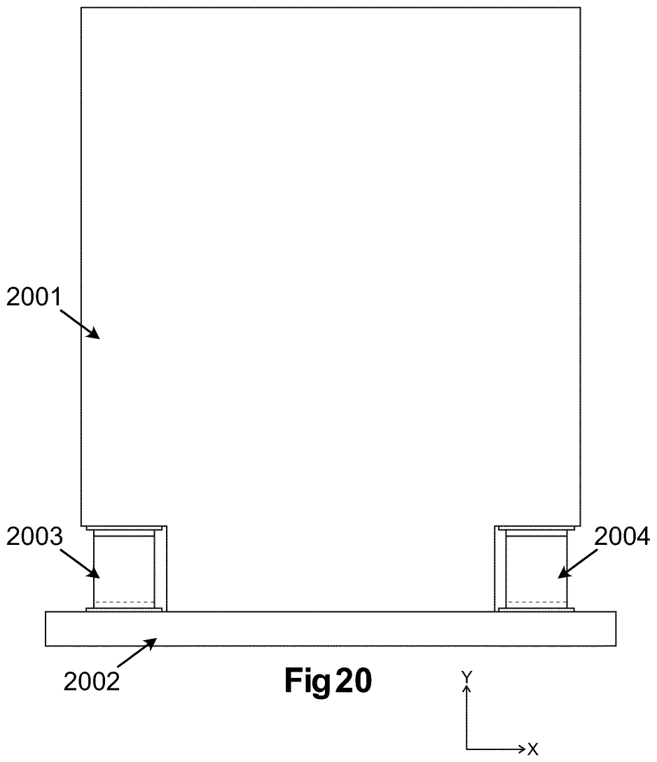

Referring to FIGS. 19A-D, a preferred embodiment of an energy dissipation device configured to dissipate axial load is shown. The energy dissipation device is shown to include top and bottom end plates 1904, wherein two outer web plates 1902 1903 are connected to the bottom end plate and an inner web plate 1901 is connected to the top end plate. The web plates 1901 1902 1903 are all parallel to each other and offset, providing a first space between the outer web plate 1902 and the inner web plate 1901 and a second space between the outer web plate 1903 and the inner web plate 1901. The web plates 1901 1902 1903 are parallel but offset in a transverse direction, providing space between for energy-absorbing elements to be positioned. A Three-dimensionally distributed array of UFPs 9 are connected to web plates 1901 1902 1903 within the first and second spaces between the offset web plates using welded, bolted, or other types of connections. Furthermore, the embodiment comprises a two-dimensionally distributed array of tension-compression friction springs 3. The UFP array is an array comprising two columns in the X direction, four rows in the Y direction, and two columns in the Z direction, wherein the UFPs 1906 of the first column in the Z direction are within the first space and the UFPs 1905 of the second column in the Z direction are within the second space. The spring array is an array comprising two columns in the X direction, one row in the Y direction, and two columns in the Z direction, wherein the springs 1908 of the first column in the Z direction are within the first space and the springs 1907 of the second column in the Z direction are within the second space. When a structure, for example, a rocking wall system (refer to FIG. 20)) is subjected to seismic or wind loading, the web plate 1901 on the top and web plates 1902 1903 on the bottom side are subjected to axial movement. Web plate 1901 and web plates 1902 1903 are moveable axially along the Y axis (longitudinal direction) of the energy dissipation device but in opposite directions when the energy dissipation device is subjected to axial loads, wherein the energy-absorbing elements are configured to dissipate shear load from relative shear movement between the web plates 1902 1903 and the web plate 1901. As web plate 1901 and web plates 1902 1903 are moved axially, The UFPs 9 flex to dissipate wind or seismic or other excitation energy, and the springs 3 assist with returning the energy dissipation device and structural components to a neutral position. The spring 3 may also contribute to energy dissipation. The embodiment as shown in FIGS. 19A-D is shown to comprise an array(s) of energy-absorbing elements including both UFPs 9 and springs 3; as described previously in regards to shear-configured energy dissipation devices with co-planar web plates, in alternative embodiments it may be preferable such that the energy dissipation device comprises an array(s) of energy-absorbing elements wherein the energy-absorbing elements consist of only springs, or only UFPs.

FIG. 20 shows a preferred embodiment of lateral-force resisting structure, a rocking wall system, comprising a first structural component being a rocking wall 2001, a second structural component being a slab 2002, and a pair of axially-configured energy dissipation devices 2003 2004 (as in FIG. 19 for example) at either end of the rocking wall 2001 wherein each energy dissipation device is connected to the rocking wall 2001 and the slab 2002 at each end. Upon the structure receiving lateral-load, for example from wind or seismic excitation energy, the energy dissipation devices receive a substantially axial load, wherein the web plates of the energy dissipation devices move axially along the longitudinal direction of the energy dissipation device, but in opposite directions, resulting in relative shear movement therein, such that the energy-absorbing elements of the energy dissipation device dissipate the shear load.

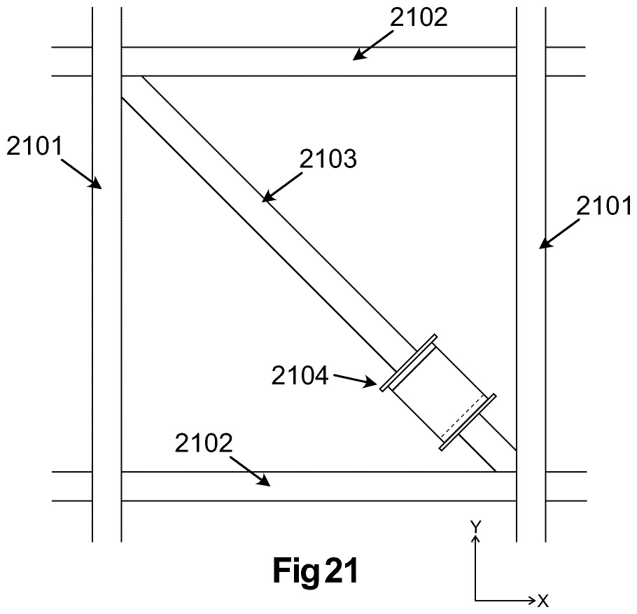

FIG. 21 shows a preferred embodiment of a lateral force-resisting structure, a diagonally braced frame, comprising a frame with columns 2101, beams 2102 connecting between said columns, and a diagonal brace 2103. The structure is shown to comprise an axially-configured energy dissipation device along the diagonal brace 2103, wherein the diagonal brace is discontinuously connected across the diagonal of the frame through the energy dissipation device. Upon the structure receiving lateral-load, for example from wind or seismic excitation energy, the energy dissipation devices receive a substantially axial load, wherein the web plates of the energy dissipation devices move axially along the longitudinal direction of the energy dissipation device, but in opposite directions, resulting in relative shear movement therein, such that the energy-absorbing elements of the energy dissipation device dissipate the shear load. The energy dissipation device is shown to be positioned toward a distal end of the diagonal brace 2103, however in alternative embodiments, the energy dissipation device may be positioned toward the centre of span of the diagonal brace. In alternative embodiments, it may be preferable to have a diagonally braced frame as described further comprise additional energy dissipation devices installed along the length of the diagonal brace 2103, preferably at each end.

In alternative embodiments, where a shear-configured energy dissipation device is positioned in between two structural components in a location that may be subjected to axial load, all UFPs of the energy dissipation device preferably comprise a connection to the web plates of the energy dissipation device that allow an amount of axial movement of the UFPs, such as a slotted connection, rubberised joint, slide rail, or other connections known to those skilled in the art.

In alternative embodiments, where an axially-configured energy dissipation device is positioned in between two structural components in a location that may be subjected to shear load, all UFPs of the energy dissipation device preferably comprise a connection to the web plates of the energy dissipation device that allow an amount of transverse movement of the UFPs, such as a slotted connection, rubberised joint, slide rail, or other connections known to those skilled in the art.

### Energy-Absorbing Units

In alternative embodiments, it may be preferable for one or more of the energy dissipation device's energy-absorbing elements to comprise two or more combined UFPs that make up an energy-absorbing unit. FIGS. 17B-F illustrates various configurations of UFPs connected to form an energy-absorbing unit.

While the embodiments as described comprise two or three-dimensionally distributed energy-absorbing elements directly connected to web plates or parallel connectors, FIGS. 17B-F shows configurations of combining a plurality of energy-absorbing elements to form an energy-absorbing unit. For example, an energy-absorbing unit may comprise a plurality of UFPs, arranged in a side-by-side 1705 in a chain or face-to-face 1706 in a pill-shape configuration. The energy-absorbing unit may also comprise at least two UFPs stacked or positioned concentrically 1708, or at least two UFPs positioned within (otherwise referred to as nested) 1709 a larger UFP. Combining energy-absorbing elements into an energy-absorbing unit may be preferably in alternative embodiments to provide various stages of energy dissipating response under shear load of the energy dissipation device, or to nest UFPs to utilise available volume within the energy dissipation device better. Although energy-absorbing elements within an energy-absorbing unit may not directly attach to a parallel connector or a web plate of an energy dissipation device as previously described, the energy-absorbing elements are indirectly attached/connected to said energy dissipation device, such that when a first structural component and a second structural component of a structure are subjected to seismic or wind loading the, the shear web plates of the energy dissipation device are subjected to subjected to shear loads, and said indirectly attached energy-absorbing elements within an energy-absorbing unit flex or deform to dissipate wind or seismic or other excitation energy. When referring to an array that comprises a columns and/or rows of energy-absorbing elements, wherein said columns or rows may comprise one or more UFPs positioned concentrically 1708 and/or nested 1709 with one or more other UFPs, the energy-absorbing elements that may contribute to a referred length of a dimension of the array may preferably be limited to the outer-most energy-absorbing element, or more simply put, an energy-absorbing unit may in preferable embodiments contribute to the length of a dimension of the array by an amount of one. For example, an array with a row of three UFPs, wherein each of the nine UFPs comprise two UFPs positioned concentrically therein, such that the row comprises nine UFPs that make up three units, the dimension of said row may preferably be referred to as three, or otherwise comprising three columns. Alternatively, for example, an array with a row of energy-absorbing elements comprising a unit of three UFPs attached in a serial side-by-side 1705 configuration as shown in FIG. 17C, it may be preferable that each UFP within the unit contribute to the length of the dimension, such that the row of the array is said to have a length of three.

### Serviceability & Reusability, & Safety

In alternative embodiments, it may be preferable that one or more UFPs may be directly or indirectly fastened to one parallel connector only. Thus, the redundant (otherwise referred to as a reserve portion) UFPs move with the parallel connector because one end of the UFP is free. After seismic or storm events, in case of UFPs' fracture, the free end of redundant UFPs can be bolted or welded to the nearby parallel connector. The redundant UFPs may enable NDSL to be repaired with minimum time and cost, while the fractured UFPs (referred to as the active portion) will not need to be removed from the building.

One or more UFPs may have a vertically slotted (perpendicular to X direction) bolted connection at one end, such that the delayed-acting UFPs flex to dissipate energy when displacement demand exceeds a specific limit. The delayed-acting UFPs may provide further energy dissipation and increase stiffness when they are required.

The energy dissipation device can be a reversible no-damage seismic and structural solution. It can be disassembled after the structures' lifetime or at any time during operational service and can be reused in any other structures/buildings. The energy dissipation device can be designed and manufactured in standard dimensions to support modular construction without increasing cost or compromising the structural performance of the energy dissipation device. Reversibility, reusability, replaceability, and standardised dimensions of the energy dissipation device can improve the sustainability and resilience of structures and buildings, and it assists the construction sector in achieving a net-zero carbon target. Thus, the energy dissipation device is a suitable structural solution for current construction technology and for the next generations of construction (construction 4.0 and 5.0 e.g., development and implementing industry 4.0 and 5.0 in the construction sector).

Reusability, replaceability, and dimension flexibility (no length limitation) of NDSLs may make them excellent solutions to retrofit of existing buildings and structures and provide a cost-effective solution to convert traditional (also known as high-damage) exiting structural structures to low-damage structural and seismic solutions. Reusability and dimension flexibility of the energy dissipation device improves buildings'/structures' transformation capability. Reversibility, reusability, and providing transformation capability make NDSLs excellent solutions to help buildings generate a large healthy footprint. Thus, NDSLs can add value to construction sustainability.

Since strain hardening likely doesn't occur in UFPs or tension-compression friction springs in the energy dissipation device, the overstrength factor for structures with the energy dissipation device is less than that for the traditional or replaceable energy dissipation device. The smaller overstrength factor for multi-storey buildings with NDSL can bring a more cost-effective building solution due to saving costs in foundations, beams, columns, connections, and braces compared to those with traditional EBF or replaceable energy dissipation devices.

An advanced numerical simulation of the first embodiment of an energy dissipation device in an EBF using detailed finite elements was conducted using ABAQUS to investigate the seismic performance of the energy dissipation device under severe earthquakes. Cyclic enforced horizontal displacement was applied at the left and right beam to column connections of the EBF simultaneously. The results of the investigation confirmed the energy dissipation device is a no-damage seismic solution that meets the requirements to resist severe earthquakes.

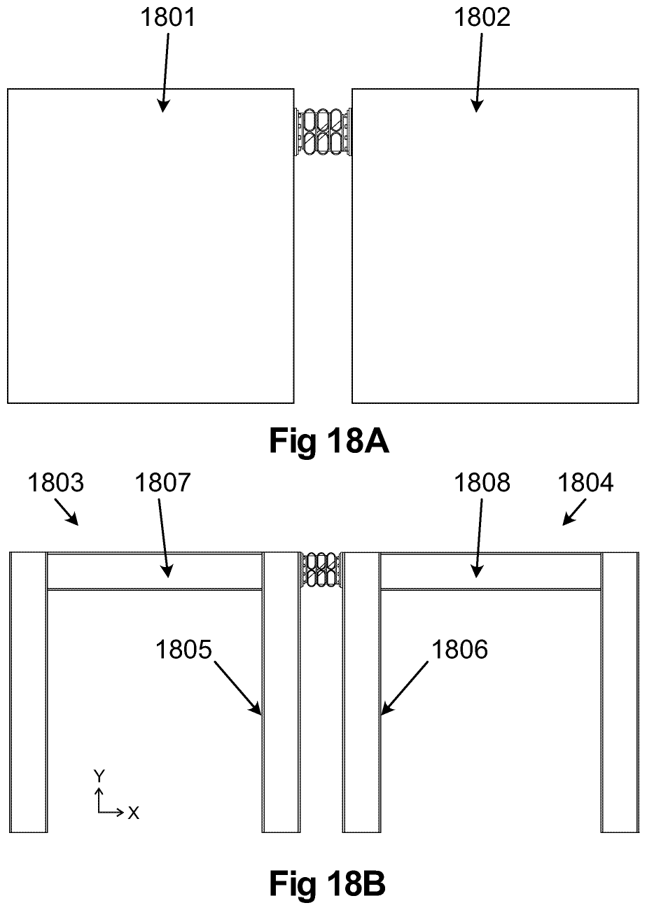

While the seismic performance of an energy dissipation device in an EBF was investigated herein, the energy dissipation device can be used in other structural systems. It also can be used for a wide variety of structures under other types of loading (e.g. wind). For example, an energy dissipation device in a shear wall or linked column lateral force-resisting structures as shown in FIGS. 18A and 18B respectively. In general, the Energy-Dissipating Device couples two structural components, which may be (or be connected to) any of the structures described or illustrated.

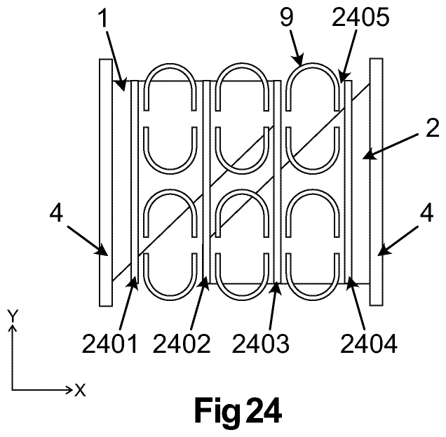

In alternative embodiments, it may be preferable that UFPs of an array of energy-absorbing elements are directly or indirectly connected to the energy dissipation device such that under high thermal temperatures, potential expansion of the energy-absorbing elements and/or other parts of the Energy-Absorbing Device is compensated for. Referring to FIG. 24, an energy dissipation device is shown with four parallel connectors 2401 2402 2403 2404 alternatingly connected to web plates 1 2. The web plates are each secured to one of the end plates 4 of the device. The energy dissipation device is shown with an array energy-absorbing elements comprising three columns of UFPs 9 connected to the parallel connectors, wherein the width of each UFP is less than the width of the corresponding space between each parallel connector, resulting in a gap 2405 on either side of each UFP. In some embodiments, this gap may be filled with a compressible packer material, such that the packer material provides reasonable stiffness for force due to relative motion of connected structural components are transferred to the UFPs, but under thermal expansion of the UFPs or other parts of the energy dissipation device or structure the energy dissipation device is within, the packer may be compressed by the UFPs. In alternative embodiments, the gap may be an empty gap not filled with a packer material, but the UFPs are connected to the parallel web plates or parallel connectors via one or more dowels, shafts, or holes to receive a dowel or shaft, that transfer a moment or shear load between the UFP and the energy dissipation device, but provide little restriction against the UFP moving along its axis.

Preferred embodiments of the invention have been described by way of example only and modifications may be made thereto without departing from the scope of the invention.

1. An energy dissipation device for use in a lateral force-resisting structure for dissipating seismic or wind-induced energy, wherein the energy dissipation device is arranged to extend along a longitudinal axis to span between a first structural component of the lateral force-resisting structure and a second structural component of the lateral force resisting structure for energy dissipative coupling therebetween, the energy dissipation device comprising:
a. a first web plate for securing to the first structural component and arranged to extend therefrom towards the second structural component;
b. a second web plate for securing to the second structural component and arranged to extend therefrom towards the first structural component; wherein the first web plate and the second web plate are separated to allow the web plates to move relative to one another in response to relative movement of the first and second structural components; and
c. an array of energy-absorbing elements coupling the first web plate to the second web plate, wherein the array has at least two orthogonal dimensions comprising of at least one row and at least one column, wherein the at least one row is defined by:
one or more energy-absorbing elements of the array of energy-absorbing elements aligned along a respective axis parallel to the longitudinal axis,
and wherein each column is defined by:
one or more energy-absorbing elements of the array of energy-absorbing elements aligned along a respective axis orthogonal to the longitudinal axis; wherein the one or more energy-absorbing elements comprise a U-shaped flexural plate (UFP) and is directly or indirectly secured to the first web plate and to the second web plate so as to deform in response to said relative movement of the first and second structural components thereby dissipating energy.

2. The energy dissipation device of claim 1, wherein the array has at least two orthogonal dimensions comprising of a plurality of rows and a plurality of columns, wherein each row is defined by the one or more energy-absorbing elements of the array of energy-absorbing elements aligned along a respective axis parallel to the longitudinal axis.

3. The energy dissipation device of claim 1, wherein each column is defined by the energy-absorbing elements of the array of energy-absorbing elements aligned along a respective axis orthogonal to the longitudinal axis; wherein the energy-absorbing elements comprise the U-shaped flexural plate (UFP) and are directly or indirectly secured to the first web plate and to the second web plate so as to deform in response to said relative shear movement of the first and second structural components thereby dissipating energy.

4. The energy dissipation device of claim 1 wherein the first web plate and the second web plate are co-planar.

5. The energy dissipation device of claim 4, wherein each web plate is a variable cross-section plate having a tapered edge, and wherein the web plates are arranged such that the tapered edges are adjacent and define a diagonal spacing therebetween.

6. The energy dissipation device of claim 1 further comprising a plurality of parallel connectors distributed along the longitudinal axis and successively alternating in connection to the first web plate or to the second web plate, wherein the one or more energy-absorbing elements in each column of the array are directly or indirectly secured between two successive parallel connectors to thereby secure the energy-absorbing elements of the array to the first web plate and to the second web plate.

7. The energy dissipation device of claim 6, wherein the one or more of energy-absorbing elements in each row is an odd number and the plurality of parallel connectors is an even number, for reducing unbalanced shear loads across the web plates.

8. The energy dissipation device of claim 6, the plurality of parallel connectors is an odd number.

9. The energy dissipation device of claim 1 wherein the one or more energy-absorbing elements in the at least one row is an even number.

10. The energy dissipation device of claim 1 wherein the array is arranged such that one side of the web plates is flanked by UFPs.

11. The energy dissipation device of claim 1 wherein the array of energy-absorbing elements has three orthogonal dimensions, the third dimension defined by a plurality of columns.

12. The energy dissipation device of claim 11, wherein the array is arranged such that both sides of the web plates are flanked by UFPs for reducing torsional load on the energy dissipation device.

13. The energy dissipation device of claim 11, wherein the array is arranged such that both sides of the web plates are flanked by UFPs for reducing torsional moment or coupled forces on the energy dissipation device or for reducing the resultant of unbalanced resisted forces by the energy dissipation device.

14. The energy dissipation device of claim 1 wherein the energy-absorbing elements in each row are rotationally aligned.

15. The energy dissipation device of claim 1 where the energy-absorbing elements in each column are rotationally aligned.

16. The energy dissipation device of claim 14 wherein the UFPs are orientated such that the legs of each UFP lie on a plane parallel to the longitudinal axis.

17. The energy dissipation device of claim 1 wherein the one or more energy-absorbing elements of the array energy-absorbing elements comprise a coupled arrangement of two or more UFPs.

18. The energy dissipation device of claim 17, wherein the one or more energy-absorbing elements of the array of energy-absorbing elements comprise a mirrored pair of UFPs in a pill-shape configuration.

19. A method of resisting lateral-loads of a structure comprising:
a. providing a plurality of energy-absorbing elements, comprising a first portion of said plurality of energy absorbing elements and a second portion of said plurality of energy absorbing elements,
b. directly or indirectly connecting the first portion of said energy-absorbing elements to a first structural component and a second structural component,
c. directly or indirectly connecting the second portion of said plurality of energy-absorbing elements to the first structural component, wherein the energy-absorbing elements of the first portion of energy-absorbing elements are subjected to shear load, due to relative movement of the first structural component and second structural component, and dissipate energy, and the energy-absorbing elements of the second portion of energy-absorbing elements are not subjected to shear load, and
d. after the first portion of energy-absorbing elements have dissipated significant energy, directly or indirectly connecting the second portion of energy-absorbing elements to the second structural component.
